(19) United States
(12) Patent Application Publication
(10) Pub. No.: US 2003/0093526 A1
(43) Pub. Date: May 15, 2003

(54) Apparatus and method for providing quality of service signaling for wireless mac layer

(75) Inventors: Saishankar Nandagopalan, Tarrytown, NY (US); Sunghyun Choi, Montvale, NJ (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N. V.

(21) Appl. No.: 10/180,570

(22) Filed: Jun. 26, 2002

Related U.S. Application Data
(60) Provisional application No. 60/351,799, filed on Nov. 13, 2001.

(51) Int. Cl. G06F 15/173

(52) U.S. Cl. 709/225; 709/249

(57) ABSTRACT

An apparatus and method is disclosed for providing Quality of Service (QoS) signaling for an IEEE 802.11e Medium Access Control (MAC) layer in a wireless local area network (WLAN). The invention comprises a WLAN that is capable of providing three types of Quality of Service (QoS) signaling to and from wireless QoS stations in the WLAN. Upstream QoS signaling establishes a QoS stream that originates from a source wireless QoS station in the WLAN. Downstream QoS signaling establishes a QoS stream that is sent to a destination wireless QoS station in the WLAN. Sidestream QoS signaling establishes a QoS stream between a source wireless QoS station and a destination wireless QoS station in the same QoS basic service set of the WLAN.

### PRIORITY CLAIM TO PROVISIONAL PATENT APPLICATION

This patent application claims priority to U.S. Provisional Patent Application Serial No. 60/351,799 filed on Nov. 13, 2001.

### TECHNICAL FIELD OF THE INVENTION

The present invention is generally directed to systems and methods for processing multimedia signals, and, in particular, to an apparatus and method for providing Quality of Service (QoS) signaling for an IEEE 802.11e Medium Access Control (MAC) layer in a wireless local area network (WLAN).

### BACKGROUND OF THE INVENTION

The development of high quality multimedia devices, such as set-top boxes, high end televisions, digital televisions, personal televisions, storage products, personal digital assistants (PDAs), wireless Internet devices, etc., is leading to a variety of architectures and to more openness towards new features for these devices. The development of these new multimedia products ensures that the public will continue to increase its demand for multimedia services. Network designers and engineers are therefore continuing to design systems that are capable of meeting the increasing demand for both real time and non-real time multimedia transfer across integrated networks.

The Internet Protocol (IP)-based Internet provides a “best effort” data delivery service that does not guarantee any service level to the users. A “best effort” service over the IP network allows the complexity to stay at the end-hosts, so that the network can remain simple. The phenomenal growth of the Internet shows that this approach scales well.

On the other hand, in recent years, the IEEE 802.11 wireless local area network (WLAN) has emerged as a prevailing technology for the (indoor) broadband wireless access for mobile/portable devices. IEEE 802.11 can be considered a wireless version of “Ethernet” by virtue of supporting a “best effort” service. The IEEE 802.11 Working Group is currently defining a new supplement to the existing legacy 802.11 Medium Access Control (MAC) layer in order to support Quality of Service (QoS). The new 802.11e MAC will expand the 802.11 application domain by enabling such applications as voice and video services over wireless local area networks (WLANs).

The new IEEE 802.11e standard will constitute the industry's first true universal wireless standard supporting QoS. IEEE 802.11e will offer seamless interoperability across home, enterprise, and public access networking environments, yet still offer features that meet the unique needs of each type of network. Unlike other wireless initiatives, IEEE 802.11e is the first wireless standard that spans home and business environments by adding QoS features and multimedia support to the existing IEEE 802.11 standard, while maintaining full backward compatibility with the legacy standard.

The QoS support for multimedia traffic is critical to wireless home networks where voice, audio, and video will be delivered across multiple networked home electronic devices and personal computers. Broadband service providers view QoS and multimedia-capable home networks as an essential ingredient to offering residential customers value-added services such as video on demand, audio on demand, voice over IP and high speed Internet access.

In order to provide adequate service, some level of quantitative and qualitative determinations of the types of network services will be required. This requires adding some capability to the network to enable the network to distinguish traffic with strict timing requirements on delay, jitter and loss from other types of traffic. This is what the protocols for QoS provisioning are designed to achieve. QoS provisioning does not create bandwidth, but manages bandwidth more effectively to meet a wide range of application requirements. The goal of QoS provisioning is to provide some level of predictability and control beyond the current IP “best effort” service.

One very important component for the QoS support is the signaling protocol, which allows the end-hosts (and the intermediate nodes) of a given QoS session to communicate the desired QoS level and the corresponding resource amount. A number of end-to-end QoS signaling protocols in the IP layer and in the LAN environment have evolved to satisfy the wide range of application needs. The most well known protocols are the Resource ReSerVation Protocol (RSVP) and its extension called Subnet Bandwidth Manager (SBM) for the LAN environments.

The challenge of any QoS protocol is to provide differentiated delivery for individual flows or aggregates without breaking the network in process. Adding an increased level of “intelligence” to the network and improving the “best effort” service represents a fundamental change to the network design that has made the Internet a great success.

There is a need in the art for coordination between the 802.11e Medium Access Control (MAC) and higher layers so that streaming applications can request and achieve their QoS requirements. There is also a need in the art to achieve some coordination between the 802.11e MAC and the higher layers to provide QoS. There is also a need in the art to transform a wireless local area network (WLAN) into a QoS network within an end-to-end QoS context.

There is therefore a need in the art for an apparatus and method that will provide improved Quality of Service (QoS) signaling for an IEEE 802.11e Medium Access Control (MAC) layer in a wireless local area network (WLAN).

### SUMMARY OF THE INVENTION

The present invention generally comprises an apparatus and method for providing improved Quality of Service (QoS) signaling for an IEEE 802.11e Medium Access Control (MAC) layer in a wireless local area network (WLAN).

In an advantageous embodiment of the present invention, the apparatus of the invention comprises a wireless local area network that is capable of providing three types of Quality of Service (QoS) signaling to and from wireless QoS stations in the WLAN. Upstream QoS signaling establishes a QoS stream that originates from a source wireless QoS station in the WLAN. Downstream QoS signaling establishes a QoS stream that is sent to a destination wireless QoS station in the WLAN. Sidestream QoS signaling establishes a QoS stream between a source wireless QoS station and a destination wireless QoS station in the same QoS basic service set of the WLAN.

The present invention provides an apparatus and method for specifying and negotiating network resources for a QoS stream based on the QoS requirements of a user. The MAC level QoS signaling of the present invention interacts with higher layer QoS signaling protocols such as Resource ReSerVation Protocol (RSVP) and Subnet Bandwidth Manager (SBM).

The present invention also provides an apparatus and method for setting up sidestream connections between a source wireless QoS station and a destination wireless QoS station within the same QoS basic service set of a wireless local area network.

It is a primary object of the present invention to provide an apparatus and method for providing Quality of Service (QoS) signaling for an IEEE 802.11e Medium Access Control (MAC) layer in a wireless local area network.

It is another object of the present invention to provide an apparatus and method for providing Quality of Service (QoS) downstream signaling for an IEEE 802.11e Medium Access Control (MAC) layer in a wireless local area network.

It is an additional object of the present invention to provide an apparatus and method for providing Quality of Service (QoS) upstream signaling for an IEEE 802.11e Medium Access Control (MAC) layer in a wireless local area network.

It is another object of the present invention to provide an apparatus and method for providing Quality of Service (QoS) sidestream signaling for an IEEE 802.11e Medium Access Control (MAC) layer in a wireless local area network.

The foregoing has outlined rather broadly the features and technical advantages of the present invention so that those skilled in the art may better understand the Detailed Description of the Invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary prior art extended service set of a wireless local area network (WLAN) comprising a host, a distribution system, a first Quality of Service (QoS) basic service set (QBSS), and a second Quality of Service (QoS) basic service set;

FIG. 2 illustrates seven prior art Open Systems Interconnection (OSI) network layers;

FIG. 3 illustrates an exemplary architecture of a Quality of Service (QoS) wireless station in accordance with the principles of the present invention;

FIG. 4 illustrates an exemplary architecture of a prior art Resource ReSerVation Protocol (RSVP) network element;

FIG. 5 illustrates an exemplary architecture of a prior art centralized Bandwidth Allocator (BA);

FIG. 6 illustrates an exemplary architecture of a prior art distributed Bandwidth Allocator (BA);

FIG. 7 illustrates a prior art frame format for IEEE 802.11e Quality of Service (QoS) data;

FIG. 8 illustrates a prior art frame format for an IEEE 802.11e Traffic Specification Element;

FIG. 9 is a flow chart illustrating a first portion of an advantageous embodiment of a method of the present invention for downstream IEEE 802.11e MAC signaling;

FIG. 10 is a flow chart illustrating a second portion of an advantageous embodiment of a method of the present invention for downstream IEEE 802.11e MAC signaling;

FIG. 11 is a flow chart illustrating a first portion of an advantageous embodiment of a method of the present invention for upstream IEEE 802.11e MAC signaling;

FIG. 12 is a flow chart illustrating a second portion of an advantageous embodiment of a method of the present invention for upstream IEEE 802.11e MAC signaling;

FIG. 13 is a flow chart illustrating a first portion of an advantageous embodiment of a method of the present invention for sidestream IEEE 802.11e MAC signaling;

FIG. 14 is a flow chart illustrating a second portion of an advantageous embodiment of a method of the present invention for sidestream IEEE 802.11e MAC signaling; and

FIG. 15 is a flow chart illustrating a portion of an advantageous embodiment of a method of the present invention for establishing a physical layer transmission rate between a source QoS station and a destination QoS station for sidestream IEEE 802.11e MAC signaling.

### DETAILED DESCRIPTION OF THE INVENTION

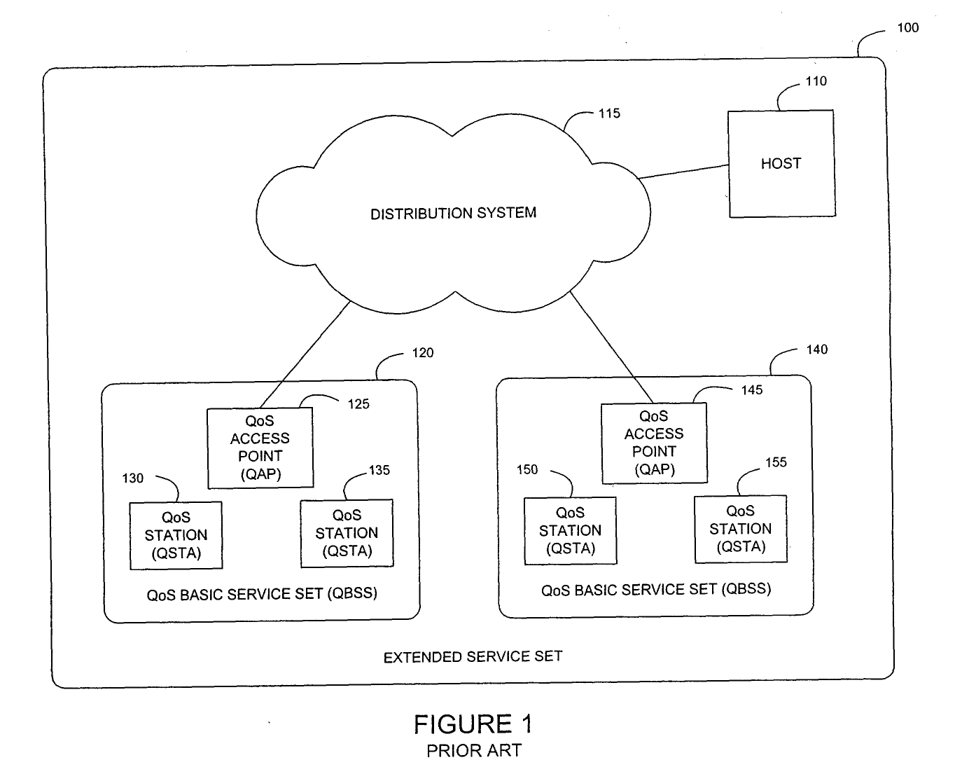

FIGS. 1 through 15, discussed below, and the various embodiments set forth in this patent document to describe the principles of the improved system and method of the present invention are by way of illustration only and should not be construed in any way to limit the scope of the invention. Those skilled in the art will readily understand that the principles of the present invention may also be successfully applied in any type of wireless network system.

FIG. 1 illustrates an exemplary prior art extended service set 100 of a wireless local area network (WLAN). Extended service set 100 comprises host 110, distribution system 115, a first Quality of Service (QoS) basic service set (QBSS) 120, and a second Quality of Service (QoS) basic service set (QBSS) 140. A QoS basic service set (QBSS) comprises a number of wireless QoS stations (QSTA) that execute the same Medium Access Control (MAC) protocol and compete for access to the same shared medium. A QBSS may be isolated or it may be connected to a distribution system. Typically, a distribution system is a wired backbone local area network (LAN).

A Quality of Service (QoS) Access Point (QAP) is a wireless QoS station that is connected to a distribution system. The QAP functions as a bridge between a QBSS and the distribution system. The MAC protocol of a QBSS may be fully distributed or controlled by a central coordination function within the QAP of the QBSS. As shown in FIG. 1, QBSS 120 is connected to distribution system 115 through QAP 125 and QBSS 140 is connected to distribution system 115 through QAP 145.

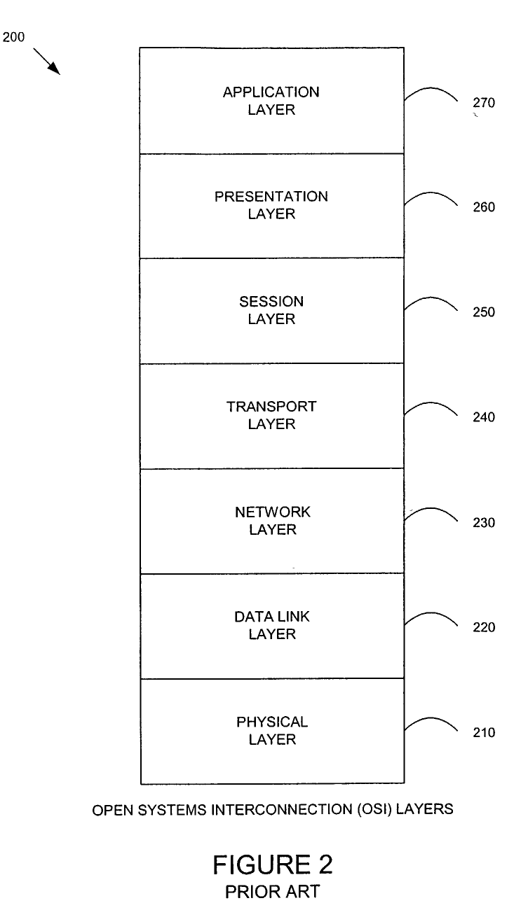

FIG. 2 illustrates seven prior art Open Systems Interconnection (OSI) network layers. These layers are well known in the art and are included here for reference. The first layer is Physical Layer 210, the second layer is Data Link Layer 220, the third layer is Network Layer 230, the fourth layer is Transport Layer 240, the fifth layer is Session Layer 250, the sixth layer is Presentation Layer 260, and the seventh layer is Application Layer 270.

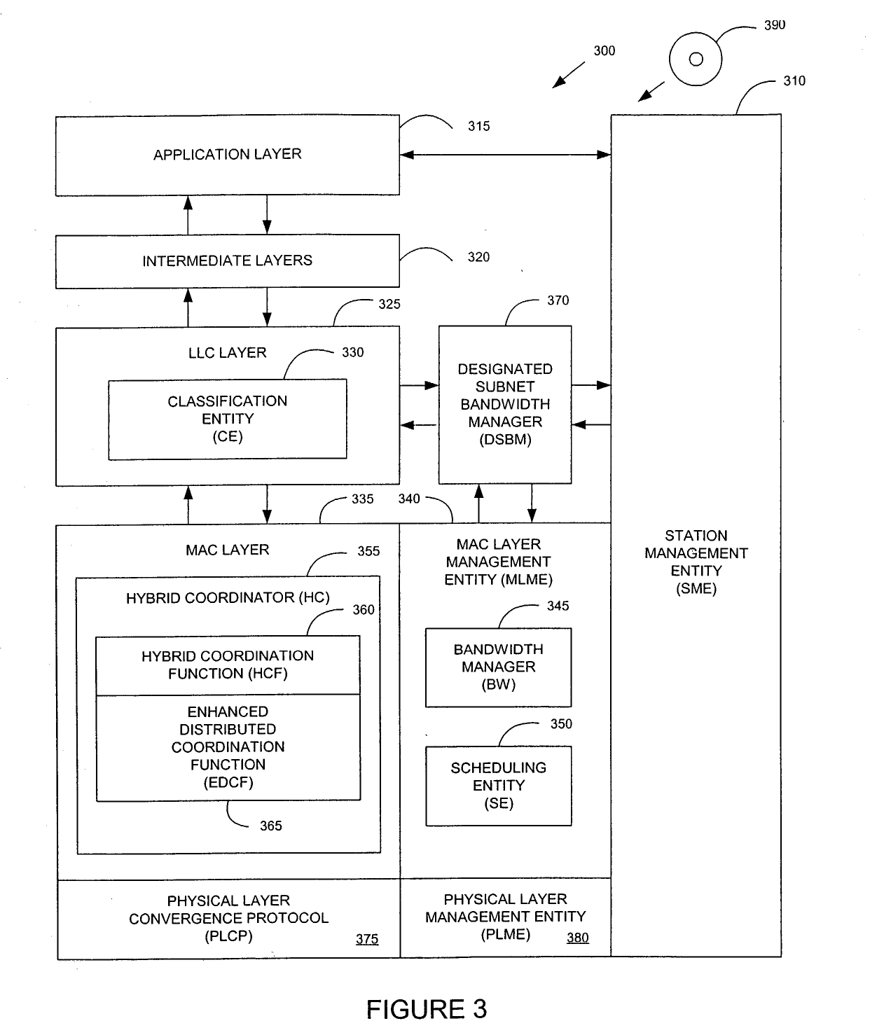

FIG. 3 illustrates an exemplary architecture 300 of a Quality of Service (QoS) wireless station (QSTA) in accordance with the principles of the present invention. Many of the elements of this architecture are well known in the art. Station Management Entity (SME) 310 extends from the Application Layer to the Physical Layer. The Physical Layer is represented in FIG. 3 by Physical Layer Convergence Protocol (PLCP) 375 and Physical Layer Management Entity (PLME) 380. MAC Layer 335 is located above the Physical Layer Convergence Protocol (PLCP) 375. MAC Layer Management Entity (MLME) 340 is located above the Physical Layer Management Entity (PLME) 380.

The Logical Link Control Layer (LLC Layer) 325 is located above MAC Layer 335. LLC Layer 325 comprises Classification Entity (CE) 330. Intermediate Layers 320 are located above LLC Layer 325. Application Layer 315 is located above Intermediate Layers 320.

MAC Layer 355 comprises Hybrid Coordinator 355. Hybrid Coordinator 355 comprises Hybrid Coordination Function (HCF) 360 and Enhanced Distributed Coordination Function (EDCF) 365. MAC Layer Management Function (MLME) 340 comprises Bandwidth Manager (BM) 345 and Scheduling Entity (SE) 350.

Designated Subnet Bandwidth Manager (DSBM) 370 is located above MAC Layer Management Function (MLME) 340. Designated Subnet Bandwidth Manager (DSBM) 370 is capable of communicating with LLC Layer 330, MAC Layer Management Function (MLME) 340, and Station Management Entity (SME) 310.

In order to provide an improved Quality of Service (QoS) signaling for an IEEE 802.11e Medium Access Control (MAC) layer in a wireless local area network (WLAN), the roles and relationships between the higher layer protocols and the IEEE 802.11e MAC need to be clearly understood. The higher layer signaling protocols like Resource ReSerVation Protocol (RSVP) and Subnet Bandwidth Manager (SBM) perform macro management and the IEEE 802.11e MAC performs micro management such as assigning different traffic streams to different queues and scheduling of service among different queues.

In the above context, MAC layer signaling is very important to carry QoS information not only from higher layers to the MAC but also between different MAC entities. To avoid potential problems as QoS protocols are implemented in the network, the end-to-end principle is still the primary focus of all QoS architects. As a result, the fundamental principle of “leave complexity at the edges and keep the network core as simple as possible” is a central theme among QoS architectures.

The apparatus and method of the present invention is applicable to different types of signaling (e.g., end-to-end signaling, MAC-level signaling for IEEE 802.11e, and internal signaling or interaction between the end-to-end signaling and the MAC-level signaling within an IEEE 802.11e station).

1. Resource ReSerVation Protocol (RSVP).

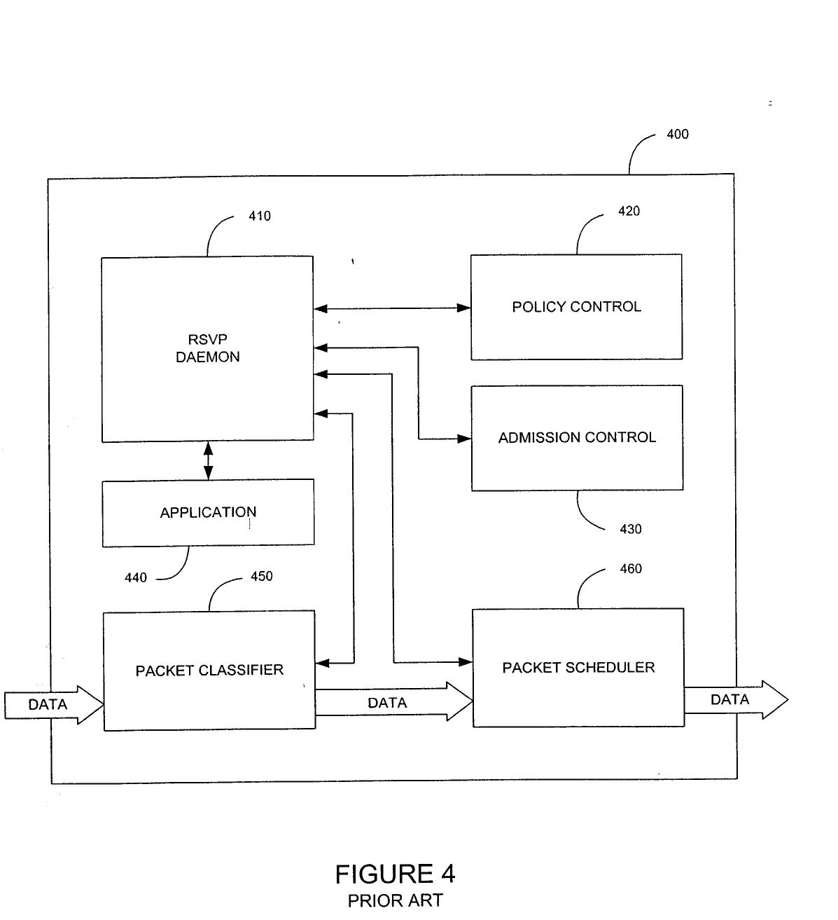

FIG. 4 illustrates an exemplary architecture of a prior art Resource ReSerVation Protocol (RSVP) network element 400. This exemplary architecture is well known in the art and is included here for reference.

Resource ReSerVation Protocol (RSVP) is a signaling protocol that provides reservation setup and control to enable the integrated service, which is intended to provide the closest model to circuit emulation on the IP networks. The RSVP is the most complex of all QoS technologies, for applications (hosts) and network elements (routers and switches). As a result, it also implements the biggest departure from the standard “best effort” IP services and provides the highest level of QoS in terms of service guarantees, granularity of resource allocation and details of feedback to QoS enabled applications and users.

The host uses RSVP to request a specific QoS level from the network, on behalf of an application data stream. RSVP carries the request through the network, visiting each node that the network uses to carry the session. At each node, RSVP attempts to make a resource reservation for the session. The receiver specifies the QoS level with which it intends to receive the traffic stream from the source. Based on this information the intermediate nodes set aside the bandwidth required for that session. To make a resource reservation at a node, RSVP daemon 410 communicates with two local decision modules, i.e., admission control module 430 and policy control module 420. The admission control module 430 determines whether the node has sufficient resources to supply the requested QoS. The policy control module 420 determines whether the user has an administrative permission to make the reservation. If either check fails, the RSVP daemon 410 returns an error notification to the application process 440 that originated the request. If both checks succeed, the RSVP daemon 410 sets parameters in a packet classifier 450 and packet scheduler 460 to achieve the desired QoS. The packet classifier 450 determines the QoS for each packet and the packet scheduler 460 orders packet transmissions to achieve the promised QoS for each session.

A primary feature of RSVP is its scalability. RSVP scales to very large multicast groups because it uses receiver-oriented reservation requests that merge as they progress up the multicast tree. The reservation for a single receiver does not need to travel to the source of a multicast tree. Rather it travels only until it reaches a reserved branch of the tree. While the RSVP protocol is designed specifically for multicast applications, it can also make unicast reservations. Additional information on the RSVP protocol may be found in Braden, R. et al., “Resource ReSerVation Protocol (RSVP) Version 1: Functional Specification,” Internet Engineering Task Force, Request For Comments 2205, September 1997.

The process of the RSVP end-to-end signaling works as follows.

(1) Senders characterize the outgoing traffic in terms of the upper and lower bounds of bandwidth, delay and jitter via TSPEC (Traffic Specification). RSVP sends a PATH message with the TSPEC information to the unicast or multicast destination addresses. Each RSVP-enabled router along the downstream route establishes a PATH state that includes the previous source address of the PATH message.

(2) To make a resource reservation, receivers send a RESV (Reservation Request) message to the sender. In addition to the TSPEC, the RESV message includes a RSPEC (Request Specification) that indicates the type of service required, either controlled load or guaranteed, and a filter specification that characterizes the packets for which the reservation is being made such as transport protocol and port number. Together, the RSPEC and filter specification represent a flow-descriptor that routers use to identify each flow or session. The RSPEC carries the QoS values with which the receiver wants that connection. This is particularly applicable in a multicast environment wherein different receivers have different QoS requirements.

(3) When each RSVP router along the routing path from a receiver to the sender receives the RESV message, it uses the admission control process to authenticate the request and allocate the necessary resources. If the request cannot be satisfied because of lack of resources or authorization failure, the router returns an error back to the receiver. If accepted, the router sends the RESV message to the next upstream router.

(4) When the last router, i.e., the router between the source and the second downstream router, receives the RESV message and accepts the request, it sends a confirmation message back to the receiver. For the multicast case, it is the place where merging of is flows occurs.

(5) There is an explicit tear-down process for releasing the reservation when sender or receiver ends an RSVP session.

RSVP enables two types of service. They are the guaranteed service and the controlled load service.

The guaranteed service comes as close as possible to emulate a dedicated virtual service. The guaranteed service provides firm (mathematically provable) bounds on end-to-end queuing delays by combining the parameters from various network elements along the routing path, in addition to ensuring bandwidth availability according to the TSPEC parameters.

The controlled load service is equivalent to the “best effort” service under unloaded conditions. Hence it is better than “best effort” but cannot provide strict guarantees.

RSVP uses a token-bucket model to characterize its input/output queuing algorithm. A token-bucket is designed to smooth the flow of outgoing traffic, but unlike the leaky-bucket mode, the token-bucket allows for higher data rates for short periods of time. The token-bucket parameters, token rate, bucket depth and peak rate are part of TSPEC and RSPEC. The RSPEC parameters are different from TSPEC parameters. Based on both TSPEC and RSPEC parameters the router decides to set aside the bandwidth and other required resources. Here is a brief overview of the RSVP parameters.

Token Rate. The Token Rate “r” is the sustainable rate for the flow measured in bytes per second. This reflects the average rate of the flow.

Token-Bucket Depth. The Token-Bucket Depth “b” is the extent to which the data rate can exceed the sustainable average for short periods of time. The Token-Bucket Depth also indicates that the amount of the data sent over any time period “t” cannot exceed “rt+b”.

Peak Rate. The Peak Rate “p” represents the maximum sending rate of the source. More precisely, the amount of data sent over time period “t” cannot exceed “pt”.

Minimum Policed Size. The Minimum Policed Size “m” is the size of the smallest packet generated by the sending application. If the packet is smaller than “m”, it is treated to be of size “m”.

Maximum Packet Size. The Maximum Packet Size “M” is the size of the biggest packet measured in bytes.

As will be seen below, these parameters should be translated into the context of IEEE 802.11e QoS support.

2. Subnet Bandwidth Manager (SBM).

QoS assurances are only as good as their weakest link. The QoS session is end-to-end between the sender and the receiver. This means that every router/bridge along the route must have support for the QoS provisioning. The sender and the receiver hosts must enable QoS so that the application can enable it explicitly or the system can enable it implicitly on behalf of the applications. Each open systems interconnection (OSI) layer from the application must be QoS-aware so that high priority traffic really receives high priority. The local area network (LAN) must enable QoS so that the high priority frames receive high priority treatment as they traverse the network media (e.g., host-to-host, host-to-router and router-to-router).

LANs (or a subnet of LANs) are normally composed of layer-2 and 1 networking devices such as Ethernet switches, bridges, and Ethernet hubs, and hence the whole such a LAN environment looks like one hop to the layer-3 routers. As a shared broadcast medium or even in its switched form, layer-2 and 1 devices provide service analogous to the “best effort” IP service in which variable delays can affect the real-time applications. However, IEEE has retrofitted the layer-2 technologies to allow for QoS support by providing protocol mechanisms for traffic differentiation.

The IEEE 802.1D standards define how layer-2 devices such as Ethernet switches can classify and prioritize frames in order to expedite delivery of real-time traffic. The Internet engineering task force (IETF) for integrated services over specific link layers (ISSLL) has defined the mapping of upper layer QoS to layer-2 technologies. The mechanism for such a mapping is called Subnet Bandwidth Manager (SBM). SBM is a signaling protocol that allows communication and coordination among end-nodes, bridges, and routers (at the edges of the LAN) in a LAN environment by enabling the mapping of higher layer QoS protocols. The fundamental requirement in the SBM framework is that all traffic must pass through at least one SBM-enabled bridge. The primary components of SBM are:

(1) Bandwidth Allocator (BA). Bandwidth Allocator maintains the states of the resource allocation on the subnet and performs the admission control according to the resources available.

(2) Requester Module (RM). Requester Module resides in every end-host as well as in any bridges. The Register Module maps between layer-2 priority values and the higher layer QoS protocol parameters according to administrator-defined policy. For example, if used with RSVP, the Requester Module will map TSPEC, RSPEC or filter spec values to layer-2 priority values.

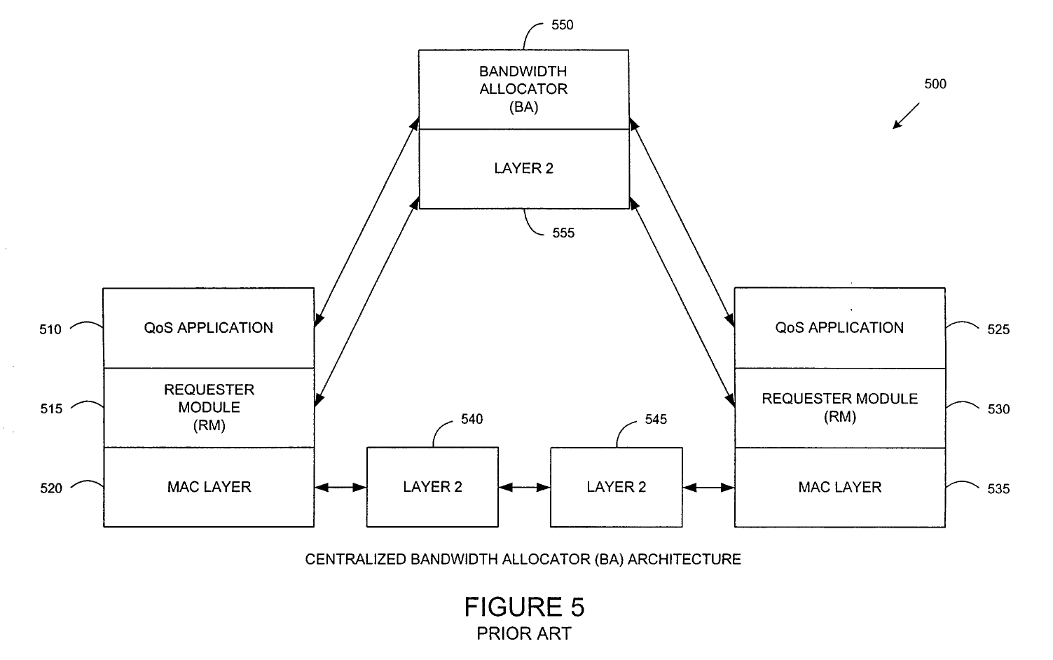

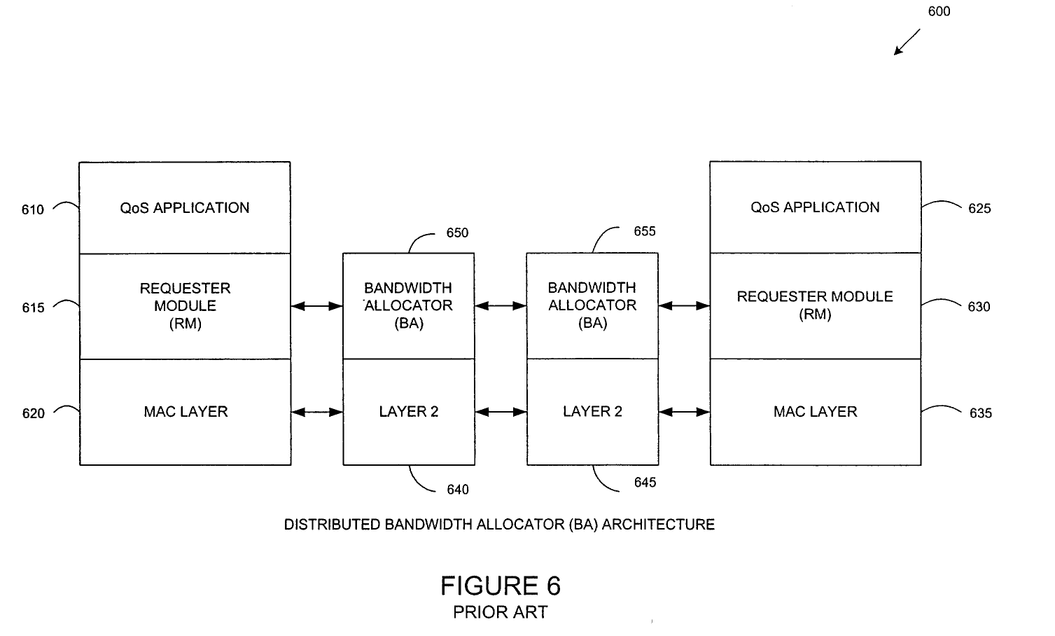

The location of the Bandwidth Allocator determines the type of SBM architecture. There are two types of architectures, namely, centralized or distributed. FIG. 5 illustrates an exemplary architecture 500 with a centralized Bandwidth Allocator (BA) 550. FIG. 6 illustrates an exemplary architecture 600 with distributed Bandwidth Allocator (BA) 650 and distributed Bandwidth Allocator (BA) 655. The exemplary architectures shown in FIG. 5 and in FIG. 6 are well known in the art and are included here for reference.

FIG. 5 illustrates a first RSVP host/router comprising QoS application 510, requester module 515, and MAC layer 520. FIG. 5 also illustrates a second RSVP host/router comprising QoS application 525, requester module 530, and MAC layer 535. Layer 2 element 540 and Layer 2 element 545 may each comprise an intermediate bridge or switch that connect the first and second RSVP hosts/routers. Centralized Bandwidth Allocator (BA) 550 is located above Layer 2 element 555. Centralized Bandwidth Allocator (BA) 550 is coupled to QoS application 510 and QoS application 525. Layer 2 element 555 is coupled to Requester Module (RM) 515 and to Requester Module (RM) 530).

FIG. 6 illustrates a first RSVP host/router comprising QoS application 610, requester module 615, and MAC layer 620. FIG. 6 also illustrates a second RSVP host/router comprising QoS application 625, requester module 630, and MAC layer 635. Layer 2 element 640 and Layer 2 element 645 may each comprise an intermediate bridge or switch that connect the first and second RSVP hosts/routers. Distributed Bandwidth Allocator (BA) 650 is located above Layer 2 element 640. Distributed Bandwidth Allocator (BA) 650 is coupled to Requester Module 615 and to Distributed Bandwidth Allocator (BA) 655. Distributed Bandwidth Allocator (BA) 655 is located above Layer 2 element 645. Distributed Bandwidth Allocator (BA) 655 is coupled to Requester Module 630 and to Distributed Bandwidth Allocator (BA) 650.

Whether there is only one or more than one Bandwidth Allocator per network segment, only one SBM is called the designated SBM (DSBM). The designated SBM may be statically configured or elected among the other SBMs. The SBM protocol provides an “RM to BA” or “BA to BA” signaling mechanism for initiating reservations, querying a BA about available resources and changing or deleting reservations. The SBM protocol is also used between the QoS-enabled application and the RM, but this involves the use of application programming interface (API) rather than the protocol. Therefore, it simply shares the functional primitives. A short description of the SBM is outlined below.

(1) DSBM initializes and keeps track of the resource limits within its network segment.

(2) A DSBM client (i.e., any RSVP-capable end-host or router) looks for the DSBM on the segment attached to each interface. This is done by monitoring the ALLSBMAddress, which is the reserved multicast IP address 224.0.0.17.

(3) When sending a PATH message, the SBM client sends it to the DSBMLogicalAddress. This is a reserved multicast address given by 224.0.0.16 rather than to destination RSVP address.

(4) Upon receiving the PATH message, the DSBM established PATH state in the bridge, stores the layer-2 and layer-3 addresses from which it came, and puts its own layer-2 and layer-3 addresses in the PATH message. The DSBM then forwards the PATH message to next hop (which may be another DSBM or the next network segment).

(5) When sending the RSVP RESV message, a host sends it to the first hop, which is a DSBM taken from the PATH message.

(6) DSBM evaluates the request and if sufficient resources are available, forwards to the next hop or else returns an error message.

3. IEEE 802.11e MAC for QoS.

As previously mentioned, an IEEE 802.11e WLAN that comprises a QoS access point (QAS) and one or more QoS stations (QSTAs) is called a QoS Basic Service Set (QBSS). The IEEE 802.11e MAC defines a single coordination function that is called the Hybrid Coordination Function (HCF). The HCF provides both controlled and contention-based channel access mechanisms. The contention-based channel access of the HCF is often referred to as the enhanced distributed coordination function (EDCF) due to its root to the legacy DCF (i.e., the legacy IEEE 802.11 MAC). The centralized coordinator is called the Hybrid Coordinator (HC) and is usually co-located in the QAP.

A. HCF Contention Based Channel Access (EDCF).

The EDCF is based on a listen-before-talk protocol called Carrier Sense Multiple Access with Collision Avoidance (CSMA/CA) where a frame can be transmitted after listening to the channel for a random amount of time. It provides differentiated channel access to frames of different priorities as labeled by a higher layer. Due to the nature of the distributed contention based channel access along with the uncertainty of the wireless medium, the EDCF cannot guarantee any rigid QoS. However, it provides so-called “prioritized” QoS that can be useful for applications that can live with statistical frame losses. With the EDCF, a single MAC can have multiple queues that work independently, in parallel, for different priorities. Frames with different priorities are transmitted using different CSMS/CA contention parameters. That is, basically a frame with a higher priority is transmitted after listening to the channel for a probabilistically shorter period than frames with lower priorities. Note that the concept of a stream supported by the EDCF does not exist. Each individual frame is treated relatively based on its corresponding priority.

B. HCF Controlled Channel Access.

The controlled channel access of the HCF is based on a polland-response protocol in which a QSTA transmits its pending frame when it receives a polling frame from the HC. As the QSTAs contend for the channel according to the EDCF channel access, the HC is given the highest priority for the channel contention. That is, the HC is subject to winning the contention by listening to the channel for a shorter time than any other QSTA before its transmission of a downlink frame or a polling frame. By polling a QSTA, the HC grants a polled transmission opportunity (TXOP) to the QSTA, where a TXOP represents a specific amount of time during which the polled QSTA, called the TXOP holder, assumes control over the channel. The duration of a polled TXOP is specified in the particular polling frame. That is, during a polled TXOP, the TXOP holder can transmit multiple frames as long as the total duration for such transactions is not over the polled TXOP duration.

Thanks to the centrally controlled characteristics, the HCF can be used for the so-called “parameterized” QoS along with “prioritized” QoS. To support the parameterized QoS, the HC and the QSTA (or QSTAs) set up a (layer-2 wireless link) stream along with the traffic characteristics and QoS requirements of the particular stream. Once such a stream is set up, the HC attempts to grant the TXOPs to the corresponding QSTAs (if the stream is from QSTA to QSTA or from QSTA to HC) or transmit the frames (if the stream is from HC to QSTA) according to the agreed specification. How to set up and maintain such a parameterized stream is handled by the MAC signaling as will be addressed in the following.

4. IEEE 802.11e MAC Signaling.

The IEEE 802.11e MAC 335 defines two different types of signaling. One type is the intra-station (Intra-STA) signaling and the other is the inter-station (Inter-STA) signaling. One Intra-STA signaling is defined between the station management entity (SME) 310 and the MAC Layer Management Entity (MLME) 340. SME 310 is a logical entity that communicates to all layers in the OSI stack while MLME 340 is a logical management entity for the MAC layer 335. Refer to FIG. 3 for the architectural overview of the relationship between SME 310 and MLME 340. The Inter-STA signaling is between two or more MAC entities within the same QBSS of an IEEE 802.11e WLAN. For example, the communications between the HC 355 and QSTAs using management frames for a stream setup belongs to this category. Another Intra-STA signaling exists between the Logical Link Control (LLC) 325 and the MAC layer 335.

A. Intra-STA Signaling Between LLC and MAC.

Each data frame that comes from the LLC 325 to the MAC 335 through the MAC Service Access Point (SAP) carries a priority value from zero (0) to fifteen (15). Within the MAC 335 this value is called the Traffic Identifier (TID). The TID values from zero (0) to seven (7) specify the actual priority of the particular frame in which the value seven (7) represents the highest priority and the value zero (0) represents the lowest priority. The frame with TID from values zero (0) to seven (7) is served via prioritized QoS based on its priority value. The TID values from eight (8) to fifteen (15) specify a corresponding traffic stream which the particular frame belongs to. That is, such a TID is just a label of the corresponding stream, and the number itself does not tell anything related to the QoS level. Each frame belonging to a traffic stream is served subject to the QoS parameter values provided to the MAC 335 in a particular traffic specification (TSPEC) agreed upon between the HC 355 and the participating QSTA(s) of the traffic stream.

B. Intra-STA Signaling Between SME and MLME.

The SME 310 and the MLME 340 interact for a number of station/layer management activities such as starting a new QBSS, scanning the channel to find a new Access Point (AP), and associating a new Access Point (AP). Out of all these different functions, consider the interaction between the SME 310 and the MLME 340 for the QoS stream setup. The MLME 340 of the QAP has two QoS-related entities. They are the Bandwidth Manager (BM) 345 and the Scheduling Entity (SE) 350. The Bandwidth Manager (BM) 345 is responsible for keeping track of the wireless bandwidth and the Scheduling Entity 350 is responsible for allocating TXOPs based on the requirements of different traffic streams.

The following MLME SAP primitives are defined for the signaling between the SME 310 and the MLME 340 as part of IEEE 802.11e to handle the traffic stream setup. Note that these MLME SAP primitives are used to support parameterized QoS, as it requires a traffic stream setup.

C. MLME SAP Primitives.

(1) MLME-ADDTS.request. MLME-ADDTS.request is sent by SME 310 to MLME 340 to initiate a stream management frame with specified parameters. This primitive requests addition or modification of a traffic stream with a specified peer MAC entity or entities capable of supporting parameterized QoS traffic transfer.

(2) MLME-ADDTS.confirm. MLME-ADDTS.confirm is sent by MLME 340 to SME 310 to confirm the transmission of a stream management frame. This primitive informs the results of the traffic stream addition or modification attempt with a specified peer MAC entity or entities.

(3) MLME-ADDTS.indication. MLME-ADDTS.indication is sent by MLME 340 to SME 310 to inform the initiation of adding or modifying a traffic stream by another peer MAC entity. This primitive is signaled when a stream management frame has arrived from the peer MAC.

(4) MLME-ADDTS.response. MLME-ADDTS.response is sent by SME 310 to MLME 340 to respond to the initiation of a traffic stream addition (or modification) by a specified QSTA MAC entity.

(5) MLME-WMSTATUS.request. MLME-WMSTATUS.request is sent by SME 310 to MLME 3340 to request the MLME 340 for the amount of channel bandwidth available, channel status and the amount in use for QoS streams. This can be generated periodically or when a QoS flow is initiated or modified.

(6) MLME-WMSTATUS.confirm. MLME-WMSTATUS.confirm is sent by MLME 340 to SME 310 to report the result in response to the MLME-WMSTATUS.request primitive.

(7) MLME-SIDESTREAM-BW-QUERY.request. MLME-SIDESTREAM-BW-QUERY.request is sent by SME 310 to MLME 340 to request the source QSTA (e.g., QSTA 130) to probe for the achievable transmission rate with the destination QSTA (e.g., QSTA 135) in the same QBSS (e.g., QBSS 120). This primitive contains the frame size and the minimum physical layer transmission rate for the stream, both derived from the RSVP PATH/RESV messages.

(8) MLME-SIDESTREAM-BW-QUERY.response. MLME-SIDESTREAM-BW-QUERY.response is sent by SME 310 to MLME 340 indicating the maximum transmission rate at which the source QSTA (e.g., QSTA 130) can sidestream to the destination QSTA (e.g., QSTA 135) in the same QBSS (e.g., QBSS 120).

(9) MLME-SIDESTREAM-BW-QUERY.indication. MLME-SIDESTREAM-BW-QUERY.indication is sent by MLME 340 to SME 310 to inform the initiation or result of probing for the achievable transmission rate for the sidestream connection by peer MAC entity. This primitive is signaled when a stream management frame has arrived from the peer MAC.

There are also MLME-DELTS.request, .confirm, .indication, and .response primitives defined to handle the tear-down process of a QoS stream. It should be noted that some primitives initiate a stream management frame while some others are signaled by receiving a QoS management frame. For example, MLME-ADDTS.request initiates a QoS stream management frame transmission while MLME-ADDTS.indication is generated when a QoS management frame is received. The actual transmission of the QoS management frame belongs to the external signaling as described below in more detail.

D. Inter-STA Signaling.

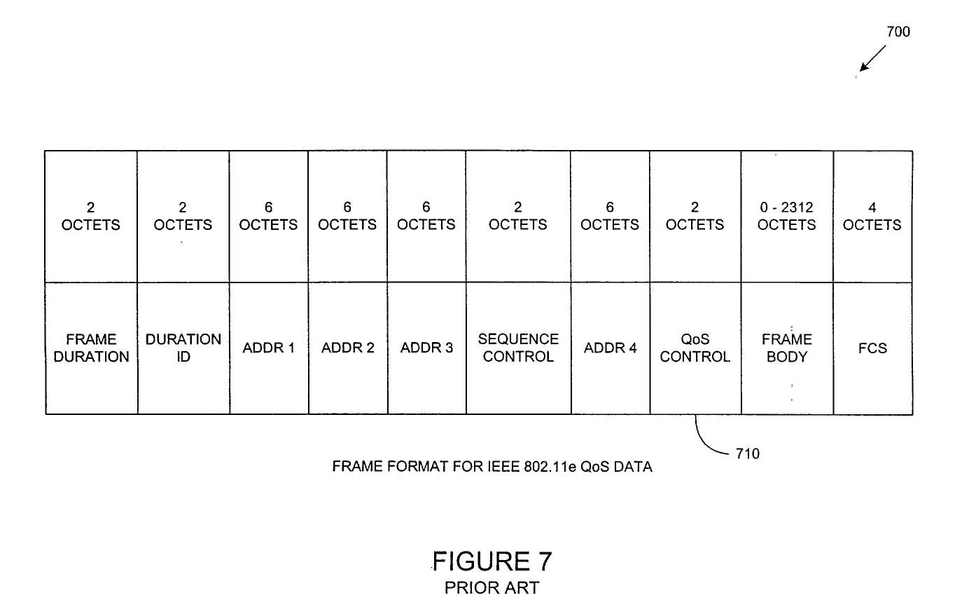

Each single QoS data frame carried the TID value which identifies the priority of the frame in case of the prioritize QoS or the corresponding traffic stream in case of the parameterized QoS. To carry such information, the IEEE 802.11e QoS data frame header is augmented by a 2-octet QoS control field 710 as shown in FIG. 7. The QoS control field uses four (4) bits to indicate the TID value and also carries some other QoS related information. For example, the status of the queue, which the specific frame was dequeued from, is also indicated to aid the TXOP grant scheduling of the HC.

Two types of QoS management frames are defined for the Inter-STA signaling to setup, modify, and delete traffic streams initiated by the corresponding MLME SAP primitives described in the previous subsection. The first type includes Add TS Request and Response QoS action frames used to set up or modify a QoS stream. The second type includes Delete TS Request and Response QoS action frames used to delete a QoS stream. Each QoS action management frame indicates the traffic specification (TSPEC) information element to communicate the corresponding QoS requirements and traffic specifications.

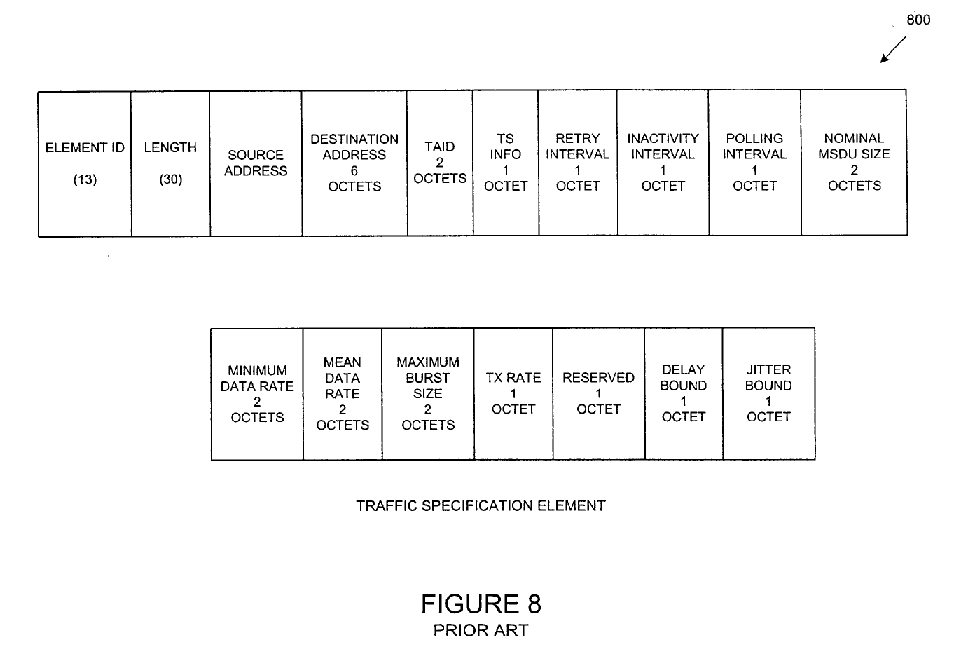

As shown in FIG. 8, the traffic specification (TSPEC) element 800 includes many quantitative objects of a traffic stream. Based on the values, the MAC layer 335 attempts to reserve bandwidth for a particular stream and honor them if they are available. Many of the entities in this element are mapped directly from the higher layer needs, e.g., specified from the RSVP PATH/RESV messages after taking into consideration the MAC layer overhead and wireless channel conditions. Those include Nominal MSDU Size, Minimum Data Rate, Mean Data Rate, Maximum Burst Size, Delay Bound, and Jitter Bound. On the other hand, some entities such as TS Info, Retry Interval, Inactivity Interval, Polling Interval, and TX Rate are more related to the different mechanisms of the MAC layer 335.

5. Interaction of RSVP/SBM and MAC Signaling.

Consider the interaction of RSVP, SBM, and the IEEE 802.11e MAC signaling for setting up a parameterized connection. It is assumed that the QAP/HC hosts the DSBM. It is assumed that SME 310 and DSBM (or BA) within the HC/QAP 355 can communicate. Although SBM was originally designed to map incoming streams to eight (8) levels of priorities (similar to IEEE 802.11e prioritized QoS) as defined in the IEEE 802.1D bridge specification, the SBM can be used to allocate bandwidth for parameterized QoS of the IEEE 802.11e WLAN. In case where the Access Point (AP) is connected to other IEEE 802 type networks, which can provide only the prioritized QoS based on eight (8) priority levels, the parameterized QoS is provided only in the IEEE 802.11e segment and not in other segments. This is not an unreasonable approach as the wireless segment is typically a bottleneck of the whole end-to-end network performance of a QoS session due to its relatively small and fluctuating bandwidth availability.

Consider a typical wired subnet wherein all the end-hosts are RSVP/SBM capable. Therefore, the signaling mechanism of the RSVP/SBM is used to route a QoS session in the wireless segment. Based on where the traffic originates and on where the traffic is destined in the segment, three scenarios become important in the wireless environment. The three scenarios are (1) downstream signaling, (2) upstream signaling, and (3) sidestream signaling.

In downstream signaling the source is a device that is connected to the wired environment and the destination is a QSTA in the QBSS. A stream is called upstream if the source is a QSTA and the destination is in the wired network. A stream is termed sidestream if the source and the destination are in the same QBSS and communicate to each other directly using the wireless medium.

It is assumed that all bandwidth reservations are done at the HC that hosts the DSBM. This is very consistent in the sense that the HC has more knowledge than any other stations in managing the bandwidth in the wireless segment. In the following, only the connection setup cases are considered. Connection deletion is similar to connection setup. The signals MLME-DELTS.request, MLME-ATTY. DELTS.confirm and MLME-DELTS.indication are used for connection deletion. This can be initiated by the receiver or source.

A. Downstream Signaling.

The host 110 in the wired network 100 communicates to QSTA 130 of QBSS 120 via the HC/QAP 125 of QBSS 120. Therefore, the stream passes from the host 110 in the wired network 100 to the QSTA in consideration (here, QSTA 130).

(1) The RSVP at the wired host 110 initiates a connection request for a QoS stream to be delivered to QSTA 130 through a PATH message. After traveling the wired network portion, the PATH message eventually reaches the DSBM that is co-located with HC/QAP 125 and is in turn forwarded to QSTA 130 as a data type frame of IEEE 802.11e. The RSVP at QSTA 130 generates a RESV message in response to the PATH message and is transmitted to the DSBM at the HC/QAP 125.

(2) The DSBM requests the channel status from the SME 310 in the HC/QAP 125.

(3) The SME 310 in HC/QAP 125 in turn communicates to the MLME 340 to obtain the information about the current channel status, which is kept track of by BM 3345 residing in MLME 340. The channel status is obtained using two MLME SAP primitives, specifically, MLME-STATUs.request and MLME-WMSTATUS.confirm. The information on the channel status is passed to the SME 310, which in turn gives it to DSBM for making the admission decision.

(4) The DSBM extracts the QoS parameters from the PATH/RESV messages for a downstream session, and makes the admission decision on the session by accounting for channel status update from the MAC 335 of HC/QAP 120 via the SME 310.

(5) If the session is admitted, then the DSBM informs SME 310 that the session can be admitted and passes the source address (SA), destination address (DA) and TID values to SME 310. SME 310 then establishes a stream identifier (SID) comprising SA, DA and TSID Field for that session.

(6) SME 310 also passes the SID and QoS values associated with the stream to the MLME 340 for reserving resources via MLME-ADDTS.request. This information is used by the scheduling entity (SE) 350 residing in MLME 340 for scheduling TXOP during the run time for the admitted stream.

(7) The MLME 340 in turns sends an Add TS Request QoS action frame containing the stream operation (Add) and QoS parameters to destination QSTA 130. After sending the management frame, the MLME 340 of HC/QAP 125 generates a MLME-ADDTS.confirm to SME 310.

(8) Upon receipt of the management frame from the HC/QAP 125, the receiving QSTA 130 checks the SID and QoS parameters of the new downstream. The MLME of QSTA 130 passes the above information to SME of QSTA 130 through MLME-ADDTS.indication. If SME of QSTA 130 decides to accept the stream, it updates itself with the stream characteristics and initiates the MLME-ADDTS.response to HC/QAP 125. If the stream characteristics were not acceptable then the SME of QSTA 130 may initiate a delete operation, as it is not able to accept the connection request.

(9) Upon receipt of the positive response from QSTA 130, the MLME 340 at the HC/QAP 125 passes that information to SME 310 through MLME-ADDTS.indication. The SME 310 then informs the DSBM, which in turn forwards the RESV message to the source in LAN environment or to the next router.

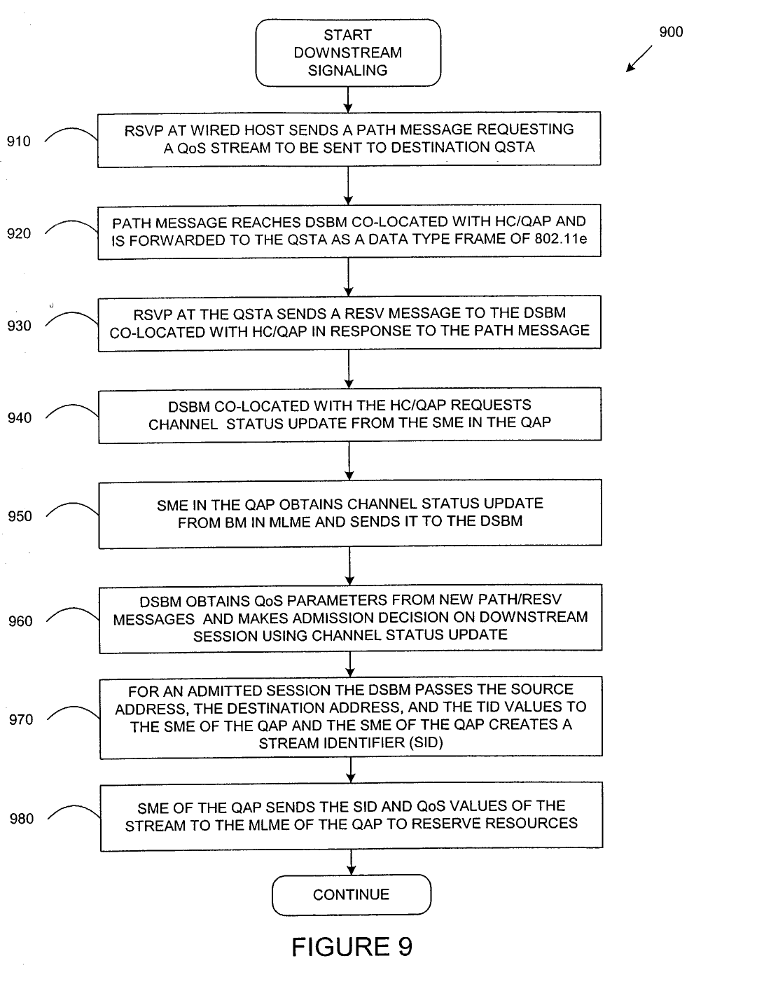

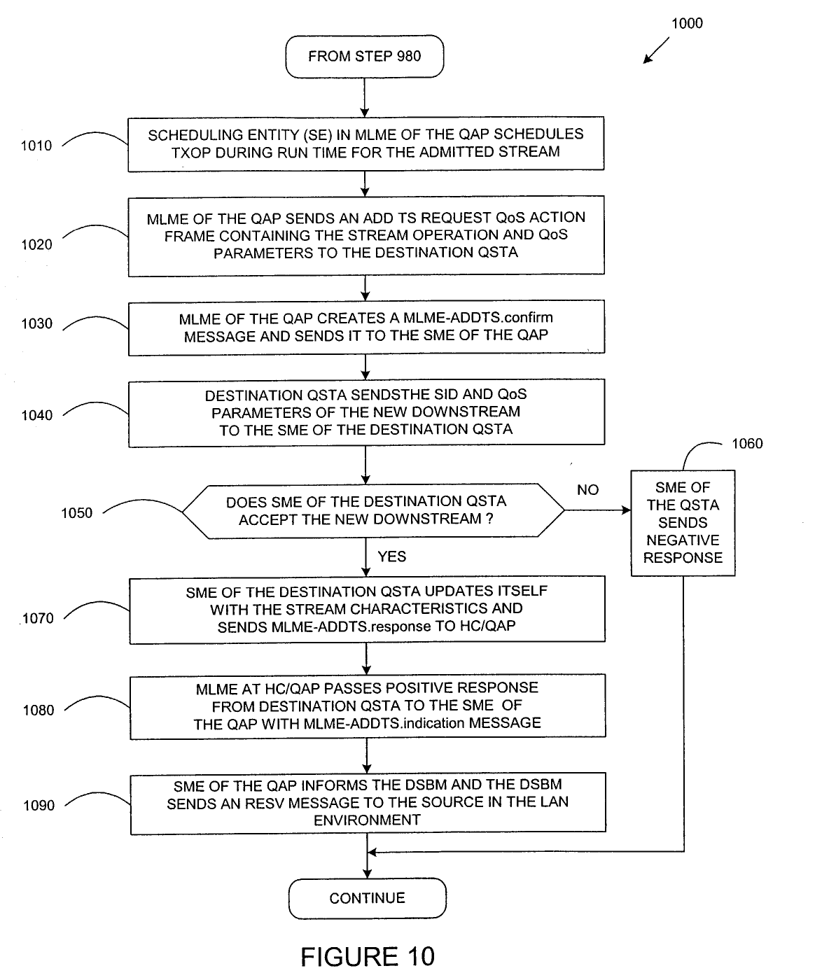

The method of downstream signaling described above is summarized in FIG. 9 and in FIG. 10. FIG. 9 is a flow chart illustrating a first portion of an advantageous embodiment of a method of the present invention for downstream IEEE 802.11e MAC signaling. The steps shown in FIG. 9 are collectively referred to with the reference numeral 900. FIG. 10 is a flow chart illustrating a second portion of an advantageous embodiment of a method of the present invention for downstream IEEE 802.11e MAC signaling. The steps shown in FIG. 10 are collectively referred to with the reference numeral 1000.

The RSVP at a wired host sends a PATH message requesting a QoS stream to be sent to the destination QSTA (step 910). The PATH message reaches the DSBM co-located with the HC/QAP and is forwarded to the destination QSTA as a data type frame of IEEE 802.11e (step 920). The RSVP at the destination QSTA sends a RESV message to the DSBM co-located with the HC/QAP (step 930).

The DSBM co-located with the HC/QAP requests a channel status update from the SME in the QAP (step 940). The SME in the QAP obtains a channel status update from the bandwidth manager (BM) in the MLME and sends it to the DSBM co-located with the HC/QAP (step 950). The DSBM obtains QoS parameters from the new PATH/RESV messages and makes an admission decision on the downstream session using the channel status update (step 960).

For an admitted session the DSBM passes the source address, the destination address, and the TID values to the SME of the QAP and the SME of the QAP creates a stream identifier (SID) (step 970). The SME of the QAP sends the SID and the QoS values of the stream to the MLME of the QAP to reserve resources (step 980).

The scheduling entity (SE) in the MLME of the QAP schedules a transmission opportunity (TXOP) during the run time for the admitted stream (step 1010). The MLME of the QAP sends an ADD TS Request QoS action frame containing the stream operation and QoS parameters to the destination QSTA (step 1020). The MLME of the QAP creates a MLME-ADDTS.confirm message and sends it to the SME of the QAP (step 1030). The destination QSTA sends the SID and QoS parameters of the new downstream to the SME of the destination QSTA (step 1040).

The SME of the destination QSTA determines whether to accept the new downstream (decision step 1050). If the SME of the destination QSTA does not accept the new downstream, then the SME of the destination QSTA sends a negative response (step 1060) and the method continues. If the SME of the destination QSTA does accept the new downstream, the SME of the destination QSTA updates itself with the stream characteristics and sends an MLME-ADDTS.response message to the HC/QAP (step 1070).

The MLME at the HC/QAP passes a positive response from the destination QSTA to the SME of the QAP using a MLME-ADDTS.indication message (step 1080). The SME of the QAP informs the DSBM and the DSBM sends an RESV message to the source in the LAN environment (step 1090).

B. Upstream Signaling.

In upstream signaling a QSTA is the initiator of the streaming connection and the recipient is a destination in the wired network. The upstream signaling goes through the HC/QAP of a QoS Basic Service Set (QBSS).

(1) The RSVP at the source QSTA 130 initiates a stream connection by sending a PATH message. This PATH message is forwarded to the DSBM residing in the HC/QAP 125, which in turn forwards the PATH message to the next DSBM or router in the wired network 100.

(2) If all the intermediate nodes have had enough resources to accommodate the requested connection, the DBSM will eventually receive a RESV message from wired network 100. On receipt of the RESV message the DSBM contacts the SME 310 of the HC/QAP 125 for the current channel state information. The DSBM also extracts the QoS parameters for that stream from the PATH/RESV message.

(3) SME 310 of HC/QAP 125 obtains the channel state information from MLME 340 using two MLME SAP primitives, specifically, MLME-WMSTATUS.request and MLME-WMSTATUS.confirm. Upon receiving the channel state update from MLME 340, SME 310 passes that information to the DSBM. Based on the- information obtained from SME 310, the DSBM makes the admission decision.

(4) If the DSBM decides to admit the session, it contacts SME 310 for confirmation and informs it that the session can be admitted and passes the source address (SA), destination address (DA) and TID values to the SME 310.

(5) The SME 310 of HC/QAP 125 passes the SID (comprising the SA, DA and TID) and QoS parameters to the MLME 340 for bandwidth allocation using a MLME-ADDTS.request message. The MLME 340 in turn sends to source wireless QoS station an Add TS Request QoS action management frame for the upstream session containing the stream operation (Add) and QoS parameters. After sending the management frame, the MLME 340 of HC/QAP 125 then generates and sends a MLME-ADDTS.confirm message to SME 310.

(6) Upon the receipt of the Add TS Request QoS action management frame, the source QSTA 130 passes the QoS parameters through an MLME-ADDTS.indication message. If SME of the source wireless QoS station decides to admit the stream, it updates itself with the stream parameters, and sends the Add TS Response QoS action frame by indicating it. If not, the negative response is sent back to the HC/QAP 125 either for renegotiation or for dropping the connection request.

(7) Upon receipt of the positive ADD TS Response QoS action frame, the MLME 340 of HC/QAP 125 informs SME 310 of QAP 125 using a MLME-ADDTS.indication message. SME 310 OF QAP 125 then informs the DSBM that the connection is accepted. The DSBM then forwards the RESV message to the source QSTA 130.

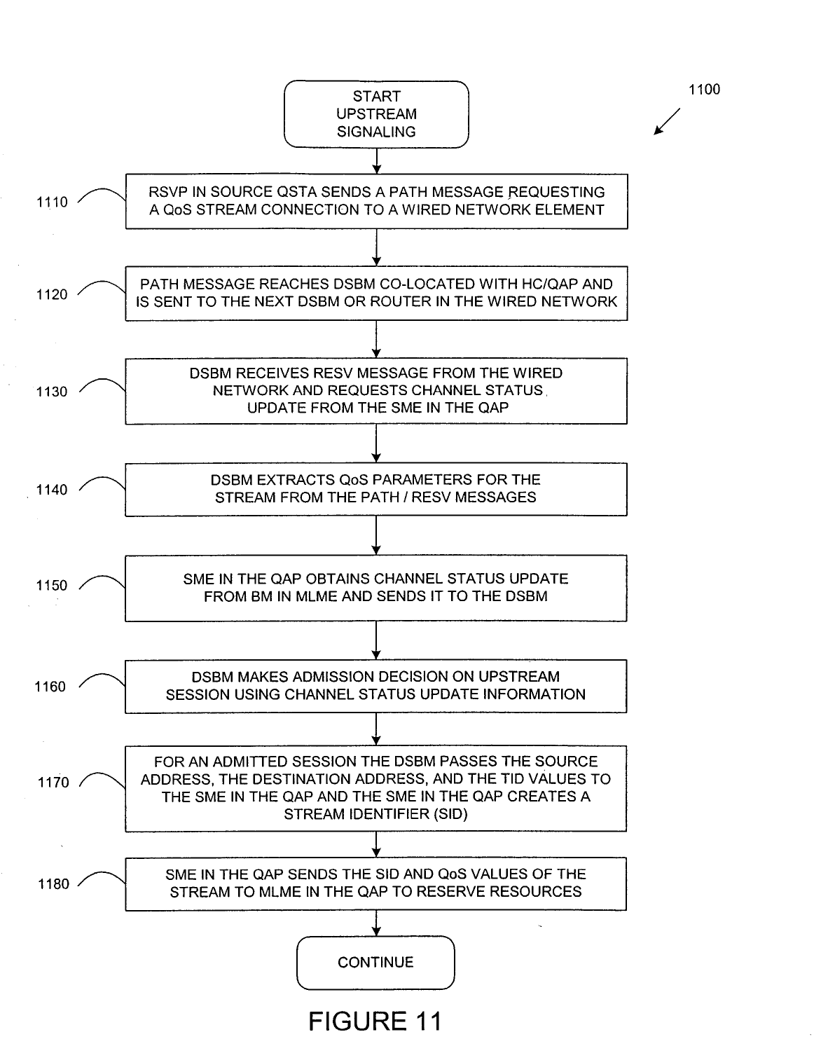

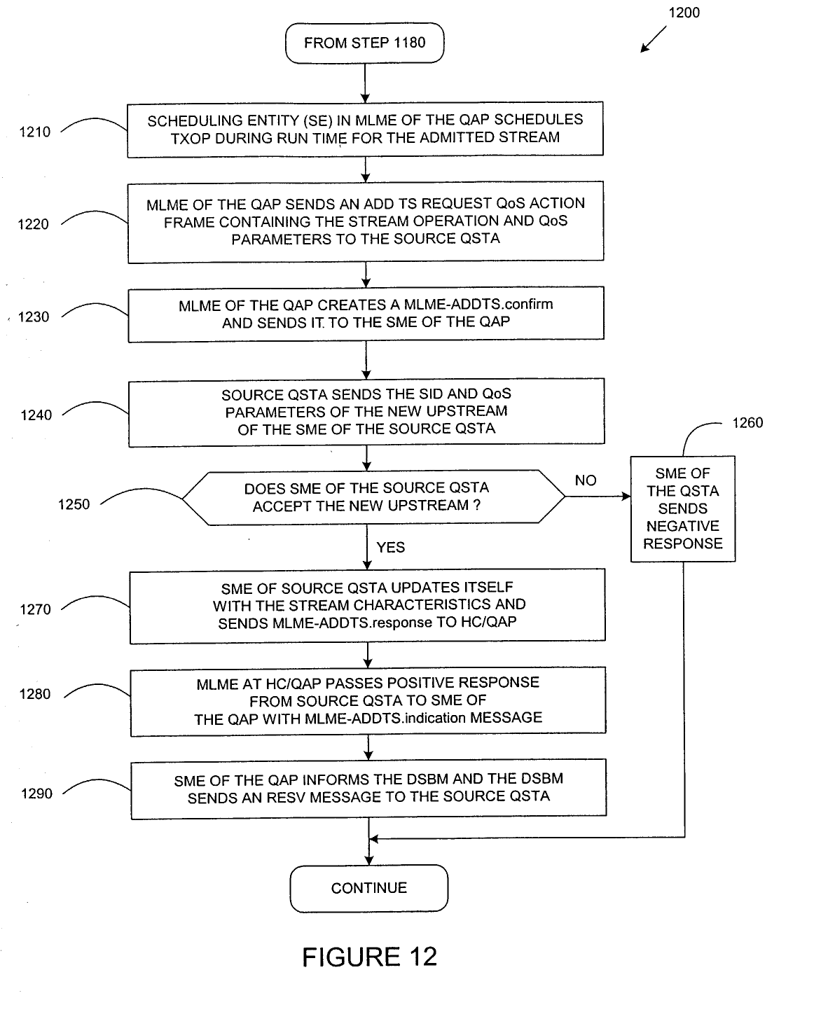

The method of upstream signaling described above is summarized in FIG. 11 and in FIG. 12. FIG. 11 is a flow chart illustrating a first portion of an advantageous embodiment of a method of the present invention for upstream IEEE 802.11e MAC signaling. The steps shown in FIG. 11 are collectively referred to with the reference numeral 1100. FIG. 12 is a flowchart illustrating a second portion of an advantageous embodiment of a method of the present invention for upstream IEEE 802.11e MAC signaling. The steps shown in FIG. 12 are collectively referred to with the reference numeral 1200.

The RSVP at a source wireless QoS station (source QSTA) sends a PATH message requesting a QoS stream connection to a wired network element (step 1110). The PATH message reaches the DSBM co-located with the HC/QAP and is sent to the next DSBM or router in the wired network (step 1120). The DSBM receives a RESV message from the wired network and requests a channel status update from the SME in the HC/QAP (step 1130).

The DSBM extracts QoS parameters for the stream from the PATH/RESV messages (step 1140). The SME in the HC/QAP obtains the channel status update from the bandwidth manager (BM) in the MLME and sends it to the DSBM (step 1150). The DSBM makes an admission decision on the upstream session using the channel status update information (step 1160).

For an admitted session the DSBM passes the source address, the destination address, and the TID values to the SME of the QAP and the SME of the QAP creates a stream identifier (SID) (step 1170). The SME of the QAP sends the SID and QoS values of the stream to the MLME of the QAP to reserve resources (step 1180).

The scheduling entity (SE) in the MLME of the QAP schedules a transmission opportunity (TXOP) during the run time for the admitted stream (step 1210). The MLME of the QAP sends an ADD TS Request QoS action frame containing the stream operation and QoS parameters to the source QSTA (step 1220). The MLME of the QAP creates a MLME-ADDTS.confirm message and sends it to the SME of the QAP (step 1230). The source QSTA sends the SID and QoS parameters of the new upstream to the SME of the source QSTA (step 1240).

The SME of the source QSTA determines whether to accept the new upstream (decision step 1250). If the SME of the source QSTA does not accept the new upstream, then the SME of the source QSTA sends a negative response (step 1260) and the method continues. If the SME of the source QSTA does accept the new downstream, then the SME of the source QSTA updates itself with the stream characteristics and sends an MLME-ADDTS.response message to the HC/QAP (step 1270).

The MLME at the HC/QAP passes a positive response from the source QSTA to the SME of the QAP using a MLME-ADDTS.indication message (step 1280). The SME of the QAP informs the DSBM and the DSBM sends an RESV message to the source QSTA (step 1290).

C. Sidestream Signaling.

In sidestream signaling both the source QSTA 130 and the destination QSTA 135 are in the same QBSS 120. The HC/QAP 125 will determine whether the communication between the source QSTA 130 and the destination QSTA 135 will be a sidestream communication or will be relayed via the HC/QAP 125. This decision is important not only for the routing information but also for conserving bandwidth of the wireless medium.

The channel state information has to be determined in a different way, as HC/QAP 125 needs to know whether the source QSTA 130 and the destination QSTA 135 can communicate with each other directly at the rate that the source QSTA 130 wants to transmit. The advantage of sidestream signaling is that it conserves bandwidth by transmitting traffic directly rather than relaying the same stream via HC/QAP 125. In the latter case the bandwidth that is consumed is twice that of the bandwidth consumed by the sidestream transmission assuming that the same transmission rate is used in the physical layer for uplink and downlink.

(1) The RSVP from source QSTA 130 initiates a PATH message. This PATH message is forwarded to the DSBM residing at HC/QAP 125 instead of the destination QSTA 135.

(2) The DSBM receives the PATH message and forwards the PATH message to the destination QSTA 135. The destination QSTA 135 initiates the RESV message, which is forwarded to the DSBM.

(3) The DSBM after receiving the RESV message will contact the SME 310 of the HC/QAP 125 for the channel status information. Since it is a communication between two stations in the same QBSS (here, QBSS 120), the HC/QAP 125 will try to determine if it is desirable for the source QSTA 130 to us sidestream signaling to destination QSTA 135 because sidestream signaling may be more bandwidth efficient. The decision whether to allow source QSTA 130 to sidestream signal or to upstream signal is left to HC/QAP 125.

(4) The SME 310 of HC/QAP 125 will make its MAC 335 generate an action frame to the source QSTA 130 by asking it to initiate a channel status update. This is done through the MMLE SAP primitive MLME-SIDESTREAM-BW-QUERY.request. This frame has the nominal frame size and the minimum physical layer transmission rate information that is required for the stream.

(5) To obtain the channel state information, the SME in the source QSTA 130 initiates a maximum transmission rate probing. Based on the nominal frame size, it generates packets at the highest rate and expects an acknowledgement from the receiver. If the receiver responds, then that rate is assumed to be the achievable physical layer transmission rate between source QSTA 130 and destination QSTA 135. If the acknowledgment is not received, the channel status probe sequence is repeated by transmitting the frames at a lower rate up to the minimum transmission rate informed by HC/QAP 125. Source QSTA 120 performs the update to determine the rate and then relays that information to the HC/QAP 125 through a response action frame. This is done using a MLME-SIDESTREAM-BW-QUERY.response message.

(6) The response is passed from the MLME to SME 310 of HC/QAP 125 using a MLME-SIDESTREAM-BW-QUERY.indication message. The SME 310 at the HC/QAP 125 on receipt of the information makes the decision whether to admit the request as sidestream signal or as upstream/downstream signal. If the minimum transmission rate is not achievable, the sidestream connection cannot be established, and accordingly upstream/downstream connection is the only candidate. The decision is passed to the DSBM.

(7) The DSBM makes a RESV message and forwards the RESV message to the source QSTA 130 for updating the RSVP connection.

Note that for sidestream signaling the TSPEC element has to have the receiver address indicating whether the stream passes through HC/QAP 125 or directly to destination QSTA 135.

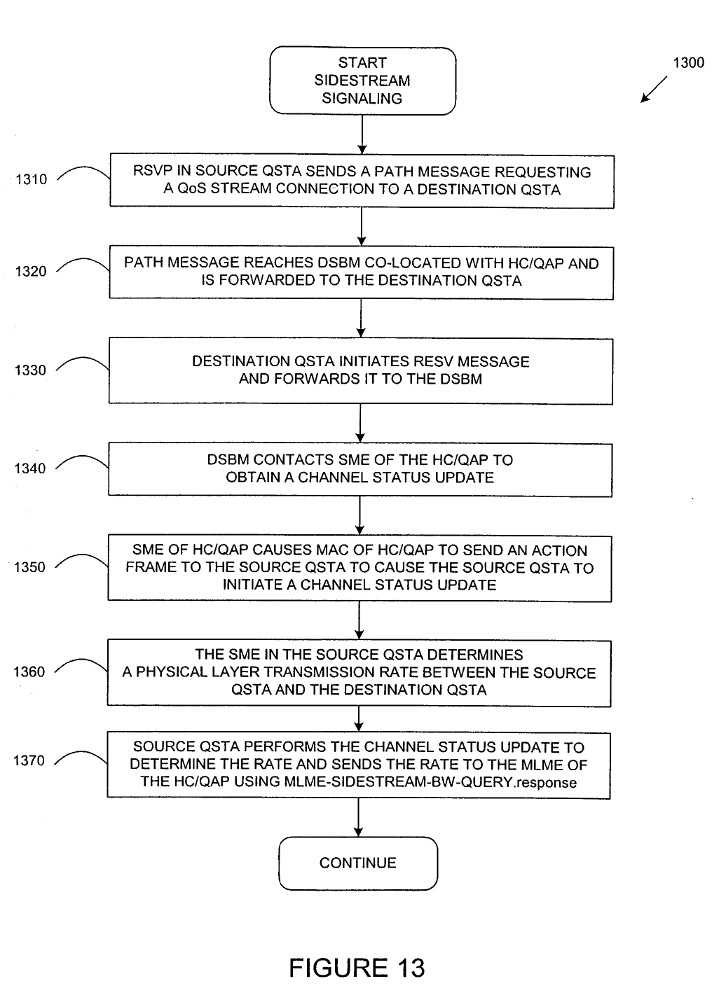

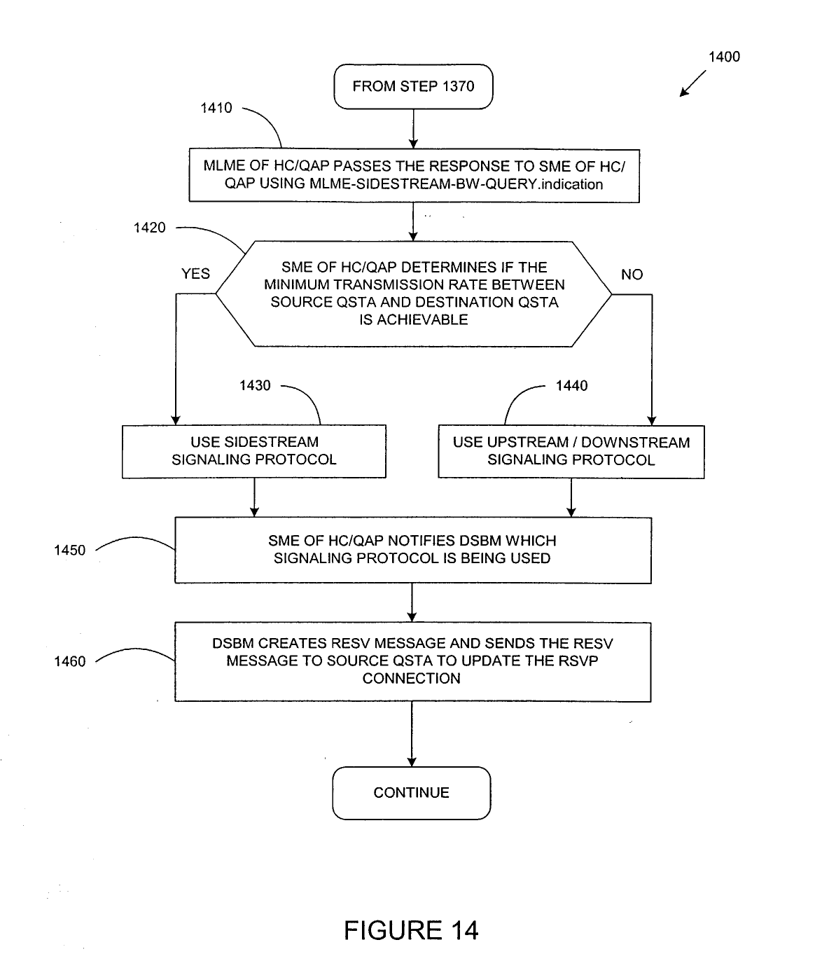

The method of sidestream signaling described above is summarized in FIG. 13 and in FIG. 14. FIG. 13 is a flow chart illustrating a first portion of an advantageous embodiment of a method of the present invention for sidestream IEEE 802.11e MAC signaling. The steps shown in FIG. 13 are collectively referred to with the reference numeral 1300. FIG. 14 is a flowchart illustrating a second portion of an advantageous embodiment of a method of the present invention for sidestream IEEE 802.11e MAC signaling. The steps shown in FIG. 14 are collectively referred to with the reference numeral 1400.

The RSVP at a source QSTA sends a PATH message requesting a QoS stream connection to a destination QSTA (step 1310). The PATH message reaches the DSBM co-located with the HC/QAP and is forwarded to the destination QSTA (step 1320). The destination QSTA initiates a RESV message and forwards it to the DSBM (step 1330). The DSBM contacts the SME of the HC/QAP and requests a channel status update (step 1340).

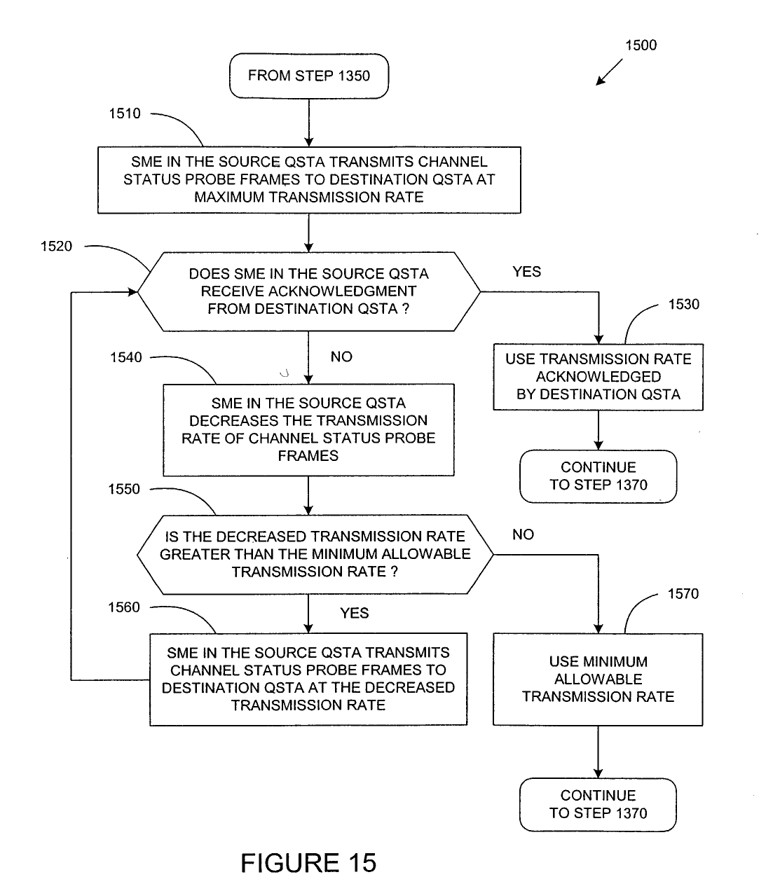

The SME of the HC/QAP causes the MAC of the HC/QAP to send an action frame to the source QSTA to cause the source QSTA to initiate a channel status update (step 1350). The SME in the source QSTA determines a physical layer transmission rate between the source QSTA and the destination QSTA (step 1360). The method of step 1360 is described more fully below with reference to FIG. 15. The source QSTA performs the channel status update to determine the rate and sends the rate to the MLME of the HC/QAP using a MLME-SIDESTREAM-BW-QUERY.response message (step 1370).

The MLME of the HC/QAP passes the response to the SME of the HC/QAP using a MLME-SIDESTREAM-BW-QUERY.indication message (step 1410). The SME of the HC/QAP then determines whether the minimum transmission rate between the source QSTA and the destination QSTA is achievable (step 1420). If the minimum transmission rate is achievable, then the sidestream signaling protocol is used (step 1430). If the minimum transmission rate is not achievable, then the upstream/downstream signaling protocol transmission rate is achievable (step 1440).

The SME of the HC/QAP notifies the DSBM which signaling protocol is being used (step 1450). The DSBM creates a RESV message and sends the RESV message to the source QSTA to update the RSVP connection (step 1460).

FIG. 15 is a flow chart illustrating a portion of an advantageous embodiment of a method of the present invention for establishing a physical layer transmission rate between a source QoS station and a destination QoS station for sidestream IEEE 802.11e MAC signaling. FIG. 15 provides additional detail concerning the method described in step 1360 of FIG. 13.

The SME in the source QSTA transmits channel status probe frames to a destination QSTA at a maximum transmission rate (step 1510). The SME in the source QSTA then determines whether it has received an acknowledgment from the destination QSTA that the destination QSTA can use the transmission rate sent by the source QSTA (decision step 1520). If the SME in the source QSTA receives such an acknowledgement from the destination QSTA, then the SME in the source QSTA uses the transmission rate that was acknowledged by the destination QSTA (step 1530). The method then continues to step 1370 of FIG. 13.

If the SME in the source QSTA does not receive such an acknowledgement from the destination QSTA, then the SME in the source QSTA decreases the transmission rate of the channel status probe frames (step 1540). The SME in the source QSTA then determines whether the decreased transmission rate is greater than the minimum allowable transmission rate (decision step 1550). If decreased transmission rate is not greater than the minimum allowable transmission rate, then the SME in the source QSTA uses the minimum allowable transmission rate (step 1570). The method then continues to step 1370 of FIG. 13.

If the decreased transmission rate is greater than the minimum allowable transmission rate, then the SME in the source QSTA transmits channel status probe frames to the destination QSTA at the decreased transmission rate (step 1560). Control then returns to step 1520 and the SME in the source QSTA determines whether it has received an acknowledgment from the destination QSTA that the destination QSTA can use the transmission rate sent by the source QSTA (decision step 1520). The process continues until the destination QSTA acknowledges a transmission rate. Control ultimately passes to step 1370 of FIG. 13.

The steps of the method of the present invention for providing Quality of Service (QoS) signaling may be carried out by computer-executable instructions stored on a computer-readable storage medium such as a DVD or a CD-ROM. Such a computer-readable storage medium is represented schematically in FIG. 3 as CD-ROM disk 390.

Although the present invention has been described in detail, those skilled in the art should understand that they can make various changes, substitutions and alterations herein without departing from the spirit and scope of the invention in its broadest form.

What is claimed is:

1. A method for providing Quality of Service (QoS) downstream signaling for an IEEE 802.11e Medium Access Control (MAC) layer in a wireless local area network comprising the steps of:
utilizing Medium Access Control (MAC) layer signaling to communicate with a higher layer signaling protocol comprising one of: a Resource ReSerVation Protocol (RSVP) higher layer signaling protocol and a Subnet Bandwidth Manager higher layer signaling protocol; and
providing a desired QoS level for said QoS downstream signaling through said higher layer signaling protocol.

2. The method as claimed in claim 1 further comprising the steps of:
creating in a network element of a wired network a connection request message comprising a PATH message of said higher layer signaling protocol for a QoS stream to be delivered to a destination wireless QoS station in a QoS basic service set of said wireless local area network, said connection request message containing QoS parameters for said QoS stream;
delivering said connection request message to said destination QoS station;
creating a connection response message comprising an RESV (Reservation Request) message of said higher layer signaling protocol in said destination QoS station in response to said connection request message;
delivering said connection response message to a designated subnet bandwidth manager co-located with a hybrid coordinator in a QoS access point of said QoS basic service set;
requesting in said designated subnet bandwidth manager a channel status update from a station management entity of said QoS access point;
obtaining in said station management entity of said QoS access point channel update information from a MAC layer management entity of said QoS access point;
delivering said channel status update information from said station management entity of said QoS access point to said designated subnet bandwidth manager; and
making an admission decision for said requested QoS stream in said designated subnet bandwidth manager using said channel status update information and said QoS parameters.

3. The method as claimed in claim 2 further comprising the steps of:
sending an internal message from said designated subnet bandwidth manager to said station management entity of said QoS access point that said requested QoS stream is admitted, said internal message comprising a source address, a destination address, and traffic identifier values;
creating in said station management entity of said QoS access point a stream identifier that comprises a source address, a destination address and a traffic stream identifier field for said QoS stream;
sending said stream identifier and said QoS parameters associated with said QoS stream to said MAC layer management entity of said QoS access point to reserve resources for said QoS stream;
sending from said MAC layer management entity of said QoS access point to said destination QoS station a QoS action frame that comprises a stream addition/modification operation and said QoS parameters;
sending an internal confirmation message from said MAC layer management entity of said QoS access point to said station management entity of said QoS access point;
sending said stream identifier and said QoS parameters of said QoS stream to a station management entity of said destination wireless QoS station; and
making an acceptance decision for said QoS stream in said station management entity of said destination wireless QoS station.

4. The method as claimed in claim 3 further comprising the steps of:
updating said station management entity of said destination wireless QoS station with stream characteristics after said QoS stream has been accepted;
sending a positive response QoS action frame to said hybrid coordinator of said QoS access point from said station management entity of said destination wireless QoS station indicating that said QoS stream has been accepted by said destination wireless QoS station;
upon receiving said positive response QoS action frame from said destination wireless QoS station, said MAC layer management entity of said QoS access point causing said scheduling entity to schedule a transmission opportunity for said QoS stream;
sending transmission opportunity scheduling information to said station management entity of said QoS access point;
sending a positive response internal message from said station management entity of said QoS access point to said designated subnet bandwidth manager; and
sending a positive response RESV (Reservation Request) message from said designated subnet bandwidth manager to said network element of said wired network that requested said QoS stream.

5. A method for providing Quality of Service (QoS) upstream signaling for an IEEE 802.11e Medium Access Control (MAC) layer in a wireless local area network comprising the steps of:
utilizing Medium Access Control (MAC) layer signaling to communicate with a higher layer signaling protocol comprising one of: a Resource ReSerVation Protocol (RSVP) higher layer signaling protocol and a Subnet Bandwidth Manager higher layer signaling protocol; and
providing a desired QoS level for said QoS upstream signaling through said higher layer signaling protocol.

6. The method as claimed in claim 5 further comprising the steps of:
creating in a source wireless QoS station in a QoS basic service set of said wireless local area network a connection request message comprising a PATH message of said higher layer signaling protocol for a QoS stream to be delivered to a destination network element of a wired network, said connection request message containing QoS parameters for said QoS stream;
sending said connection request message from said source wireless QoS station to said destination network element;
delivering a connection response message comprising an RESV (Reservation Request) message of said higher layer signaling protocol from said destination network element to a designated subnet bandwidth manager co-located with a hybrid coordinator in a QoS access point of said QoS basic service set;
requesting in said designated subnet bandwidth manager a channel status update from a station management entity of said QoS access point;
obtaining in said designated subnet bandwidth manager QoS parameters for said QoS stream from said connection request message and from said response message;
obtaining in said station management entity of said QoS access point channel update information from a MAC layer management entity of said QoS access point;
delivering said channel status update information from said station management entity of said QoS access point to said designated subnet bandwidth manager; and
making an admission decision for said requested QoS stream in said designated subnet bandwidth manager using said channel status update information and said QoS parameters.

7. The method as claimed in claim 6 further comprising the steps of:
sending an internal message from said designated subnet bandwidth manager to said station management entity of said Qos access point that said requested QoS stream is admitted, said internal message comprising a source address, a destination address, and traffic identifier values;
creating in said station management entity of said QoS access point a stream identifier that comprises a source address, a destination address and a traffic stream identifier field for said QoS stream;
sending said stream identifier and said QoS parameters associated with said QoS stream to said MAC layer management entity of said QoS access point to reserve resources for said QoS stream;
sending from said MAC layer management entity of said QoS access point to said source QoS station a QoS action frame that comprises a stream addition/modification operation and said QoS parameters;
sending an internal confirmation message from said MAC layer management entity of said QoS access point to said station management entity of said QoS access point;
sending said stream identifier and said QoS parameters of said QoS stream to a station management entity of said source wireless QoS station; and
making an acceptance decision for said QoS stream in said station management entity of said source wireless QoS station.

8. The method as claimed in claim 7 further comprising the steps of:
updating said station management entity of said source wireless QoS station with stream characteristics after said QoS stream has been accepted;
sending a positive response QoS action frame to said hybrid coordinator of said QoS access point from said station management entity of said source wireless QoS station indicating that said QoS stream has been accepted by said source wireless QoS station;
upon receiving said positive response QoS action frame from said source wireless QoS station, said MAC layer management entity of said QoS access point causing said scheduling entity to schedule a transmission opportunity for said QoS stream;
sending transmission opportunity scheduling information to said station management entity of said QoS access point;
sending a positive response internal message from said station management entity of said QoS access point to said designated subnet bandwidth manager; and
sending a positive response RESV (Reservation Request) message from said designated subnet bandwidth manager to said source wireless QoS station that requested said QoS stream.

9. A method for providing Quality of Service (QoS) sidestream signaling for an IEEE 802.11e Medium Access Control (MAC) layer in a wireless local area network comprising the steps of:
utilizing Medium Access Control (MAC) layer signaling to communicate with a higher layer signaling protocol comprising one of: a Resource ReSerVation Protocol (RSVP) higher layer signaling protocol and a Subnet Bandwidth Manager higher layer signaling protocol; and
providing a desired QoS level for said QoS sidestream signaling through said higher layer signaling protocol.

10. The method as claimed in claim 9 further comprising the step of:
determining in a hybrid coordinator of a QoS access point in a QoS basic service set whether a source wireless QoS station in said QoS basic service set is capable of communicating directly with a destination wireless QoS station in said QoS basic service set.

11. The method as claimed in claim 9 further comprising the steps of:
creating in a source wireless QoS station in a QoS basic service set of said wireless local area network a connection request message comprising a PATH message of said higher layer signaling protocol for a QoS stream to be delivered to a destination wireless QoS station in said QoS basic service set, said connection request message containing QoS parameters for said QoS stream;
delivering said connection request message from said source wireless QoS station to said destination wireless QoS station;
creating a connection response message comprising an RESV (Resource Reservation) message of said higher layer signaling protocol in said destination wireless QoS station in response to said connection request message;
delivering said connection response message from said destination wireless QoS station to a designated subnet bandwidth manager co-located with a hybrid coordinator in a QoS access point of said QoS basic service set;
requesting in said designated subnet bandwidth manager a channel status update from a station management entity of said QoS access point;
sending an action frame message from a MAC layer management entity of said QoS access point to said source wireless QoS station to initiate a channel status update;
determining in a station management entity of said source wireless QoS station a physical layer transmission rate between said source wireless QoS station and said destination wireless QoS station;
performing a channel status update in said source wireless QoS station to determine said physical layer transmission rate; and
sending said physical layer transmission rate to said MAC layer management entity of said QoS access point with a response action frame.

12. The method as claimed in claim 11 further comprising the steps of:
sending a response action frame from said MAC layer management entity of said QoS access point to said station management entity of said QoS access point;
determining in said station management entity of said QoS access point whether a minimum transmission rate between said source wireless QoS station and said destination wireless QoS station is achievable; and
when it is not possible for said source wireless QoS station and said destination wireless QoS station to communicate with each other directly, using said QoS access point to send said QoS stream after determining that said minimum transmission rate is not achievable.

13. The method as claimed in claim 12 further comprising the steps of:
sending an internal message from said station management entity of said QoS access point to said designated subnet bandwidth manager that informs said designated subnet bandwidth manager which type of communication between said source wireless QoS station and said destination wireless QoS station is being used; and
sending a higher layer response message comprising an RESV (Reservation Request) message of said higher layer signaling protocol from said designated subnet bandwidth manager to said source wireless QoS station to update a QoS protocol connection.

14. The method as claimed in claim 11 wherein the step of determining in a station management entity of said source wireless QoS station a physical layer transmission rate between said source wireless QoS station and said destination wireless QoS station comprises the steps of:
transmitting channel status probe frames at a maximum transmission rate from said station management entity of said source wireless QoS station to said destination wireless QoS station;
determining whether said destination wireless QoS station acknowledges the maximum transmission rate;
using said maximum transmission rate as said physical layer transmission rate if said destination wireless QoS station acknowledges the maximum transmission rate;
decreasing the transmission rate of said channel status probe frames to be transmitted to said destination wireless QoS station;
using said decreased transmission rate as said physical layer transmission rate if said decreased transmission rate is not greater than the minimum allowable transmission rate;
transmitting channel status probe frames at said decreased transmission rate from said station management entity of said source wireless QoS station to said destination wireless QoS station;
determining whether said destination wireless QoS station acknowledges said decreased transmission rate; and
using said decreased transmission rate as said physical layer transmission rate if said destination wireless QoS station acknowledges said decreased transmission rate.

15. A wireless local area network capable of providing Quality of Service (QoS) downstream signaling for an IEEE 802.11e Medium Access Control (MAC) layer in at least one wireless QoS station in said wireless local area network, wherein said wireless local area network is capable of:
utilizing Medium Access Control (MAC) layer signaling to communicate with a higher layer signaling protocol comprising one of: a Resource ReSerVation Protocol (RSVP) higher layer signaling protocol and a Subnet Bandwidth Manager higher layer signaling protocol; and
providing a desired QoS level for said QoS downstream signaling through said higher layer signaling protocol.

16. A wireless local area network as claimed in claim 15 wherein said wireless local area network is capable of:
creating in a network element of a wired network a connection request message comprising a PATH message of said higher layer signaling protocol for a QoS stream to be delivered to a destination wireless QoS station in a QoS basic service set of said wireless local area network, said connection request message containing QoS parameters for said QoS stream;
delivering said connection request message to said destination QoS station;
creating a connection response message comprising an RESV (Reservation Request) message of said higher layer signaling protocol in said destination QoS station in response to said connection request message;
delivering said connection response message to a designated subnet bandwidth manager co-located with a hybrid coordinator in a QoS access point of said QoS basic service set;
requesting in said designated subnet bandwidth manager a channel status update from a station management entity of said QoS access point;
obtaining in said station management entity of said QoS access point channel update information from a MAC layer management entity of said QoS access point;
delivering said channel status update information from said station management entity of said QoS access point to said designated subnet bandwidth manager; and
making an admission decision for said requested QoS stream in said designated subnet bandwidth manager using said channel status update information and said QoS parameters.

17. The wireless local area network as claimed in claim 16 wherein said wireless local area network is further capable of:
sending an internal message from said designated subnet bandwidth manager to said station management entity of said QoS access point that said requested QoS stream is admitted, said internal message comprising a source address, a destination address, and traffic identifier values;
creating in said station management entity of said QoS access point a stream identifier that comprises a source address, a destination address and a traffic stream identifier field for said QoS stream;
sending said stream identifier and said QoS parameters associated with said QoS stream to said MAC layer management entity of said QoS access point to reserve resources for said QoS stream;
sending from said MAC layer management entity of said QoS access point to said destination QoS station a QoS action frame that comprises a stream addition/modification operation and said QoS parameters;
sending an internal confirmation message from said MAC layer management entity of said QoS access point to said station management entity of said QoS access point;
sending said stream identifier and said QoS parameters of said QoS stream to a station management entity of said destination wireless QoS station; and
making an acceptance decision for said QoS stream in said station management entity of said destination wireless QoS station.

18. The wireless local area network as claimed in claim 17 wherein said wireless local area network is further capable of:
updating said station management entity of said destination wireless QoS station with stream characteristics after said QoS stream has been accepted;
sending a positive response QoS action frame to said hybrid coordinator of said QoS access point from said station management entity of said destination wireless QoS station indicating that said QoS stream has been accepted by said destination wireless QoS station;
upon receiving said positive response QoS action frame from said destination wireless QoS station, said MAC layer management entity of said QoS access point causing said scheduling entity to schedule a transmission opportunity for said QoS stream;
sending transmission opportunity scheduling information to said station management entity of said QoS access point;
sending a positive response internal message from said station management entity of said QoS access point to said designated subnet bandwidth manager; and
sending a positive response RESV (Reservation Request) message from said designated subnet bandwidth manager to said network element of said wired network that requested said QoS stream.

19. A wireless local area network capable of providing Quality of Service (QoS) upstream signaling for an IEEE 802.11e Medium Access Control (MAC) layer in at least one wireless QoS station in said wireless local area network, wherein said wireless local area network is capable of:
utilizing Medium Access Control (MAC) layer signaling to communicate with a higher layer signaling protocol comprising one of: a Resource ReSerVation Protocol (RSVP) higher layer signaling protocol and a Subnet Bandwidth Manager higher layer signaling protocol; and
providing a desired QoS level for said QoS upstream signaling through said higher layer signaling protocol.

20. A wireless local area network as claimed in claim 19, wherein said wireless local area network is capable of:
creating in a source wireless QoS station in a QoS basic service set of said wireless local area network a connection request message comprising a PATH message of said higher layer signaling protocol for a QoS stream to be delivered to a destination network element of a wired network, said connection request message containing QoS parameters for said QoS stream;
sending said connection request message from said source wireless QoS station to said destination network element;
delivering a connection response message comprising an RESV (Reservation Request) message of said higher layer signaling protocol from said destination network element to a designated subnet bandwidth manager co-located with a hybrid coordinator in a QoS access point of said QoS basic service set;
requesting in said designated subnet bandwidth manager a channel status update from a station management entity of said QoS access point;
obtaining in said designated subnet bandwidth manager QoS parameters for said QoS stream from said connection request message and from said response message;
obtaining in said station management entity of said QoS access point channel update information from a MAC layer management entity of said QoS access point;
delivering said channel status update information from said station management entity of said QoS access point to said designated subnet bandwidth manager; and
making an admission decision for said requested QoS stream in said designated subnet bandwidth manager using said channel status update information and said QoS parameters.

21. The wireless local area network as claimed in claim 20 wherein said wireless local area network is further capable of:
sending an internal message from said designated subnet bandwidth manager to said station management entity of said QoS access point that said requested QoS stream is admitted, said message comprising a source address, a destination address, and traffic identifier values;
creating in said station management entity of said QoS access point a stream identifier that comprises a source address, a destination address and a traffic stream identifier field for said QoS stream;
sending said stream identifier and said QoS parameters associated with said QoS stream to said MAC layer management entity of said QoS access point to reserve resources for said QoS stream;
sending from said MAC layer management entity of said QoS access point to said source QoS station a QoS action frame that comprises a stream addition/modification operation and said QoS parameters;
sending a confirmation message from said MAC layer management entity of said QoS access point to said station management entity of said QoS access point;
sending said stream identifier and said QoS parameters of said QoS stream to a station management entity of said source wireless QoS station; and
making an acceptance decision for said QoS stream in said station management entity of said source wireless QoS station.

22. The wireless local area network as claimed in claim 21 wherein said wireless local area network is further capable of:
updating said station management entity of said source wireless QoS station with stream characteristics after said QoS stream has been accepted;
sending a positive response QoS action frame to said hybrid coordinator of said QoS access point from said station management entity of said source wireless QoS station indicating that said QoS stream has been accepted by said source wireless QoS station;
upon receiving said positive response QoS action frame from said source wireless QoS station, said MAC layer management entity of said QoS access point causing said scheduling entity to schedule a transmission opportunity for said QoS stream;
sending transmission opportunity scheduling information to said station management entity of said QoS access point;
sending a positive response internal message from said station management entity of said QoS access point to said designated subnet bandwidth manager; and
sending a positive response RESV (Reservation Request) message from said designated subnet bandwidth manager to said source wireless QoS station that requested said QoS stream.

23. A wireless local area network capable of providing Quality of Service (QoS) sidestream signaling for an IEEE 802.11e Medium Access Control (MAC) layer in at least one wireless QoS station in said wireless local area network, said wireless local area network capable of:
utilizing Medium Access Control (MAC) layer signaling to communicate with a higher layer signaling protocol comprising one of: a Resource ReSerVation Protocol (RSVP) higher layer signaling protocol and a Subnet Bandwidth Manager higher layer signaling protocol; and
providing a desired QoS level for said QoS sidestream signaling through said higher layer signaling protocol.

24. The wireless local area network as claimed in claim 23 wherein said wireless local area network is further capable of:
determining in a hybrid coordinator of a QoS access point in a QoS basic service set whether a source wireless QoS station in said QoS basic service set is capable of communicating directly with a destination wireless QoS station in said QoS basic service set.

25. The wireless local area network as claimed in claim 23 wherein said wireless local area network is further capable of:
creating in a source wireless QoS station in a QoS basic service set of said wireless local area network a connection request message comprising a PATH message of said higher layer signaling protocol for a QoS stream to be delivered to a destination wireless QoS station in said QoS basic service set, said connection request message containing QoS parameters for said QoS stream;
sending said connection request message from said source wireless QoS station to said destination wireless QoS station;
creating a connection response message comprising an RESV (Resource Reservation) message of said higher layer signaling protocol in said destination wireless QoS station in response to said connection request message;
delivering said connection response message from said destination wireless QoS station to a designated subnet bandwidth manager in a hybrid coordinator in a QoS access point of said QoS basic service set;
requesting in said designated subnet bandwidth manager a channel status update from a station management entity of said QoS access point;
sending an action frame message from a MAC layer management entity of said QoS access point to said source wireless QoS station to initiate a channel status update;
determining in a station management entity of said source wireless QoS station a physical layer transmission rate between said source wireless QoS station and said destination wireless QoS station;
performing a channel status update in said source wireless QoS station to determine said physical layer transmission rate; and
sending said physical layer transmission rate to said MAC layer management entity of said QoS access point with a response action frame.

26. The wireless local area network as claimed in claim 25 wherein said wireless local area network is further capable of:
sending a response action frame from said MAC layer management entity of said QoS access point to said station management entity of said QoS access point;
determining in said station management entity of said QoS access point whether a minimum transmission rate between said source wireless QoS station and said destination wireless QoS station is achievable; and
when it is not possible for said source wireless QoS station and said destination wireless QoS station to communicate with each other directly, using said QoS access point to send said QoS stream after determining that said minimum transmission rate is not achievable.

27. The wireless local area network as claimed in claim 26 wherein said wireless local area network is further capable of:
sending an internal message from said station management entity of said QoS access point to said designated subnet bandwidth manager that informs said designated subnet bandwidth manager which type of communication between said source wireless QoS station and said destination wireless QoS station is being used; and
sending a higher layer response message comprising an RESV (Reservation Request) message of said higher layer signaling protocol from said designated subnet bandwidth manager to said source wireless QoS station to update a QoS protocol connection.

28. The wireless local area network as claimed in claim 25 wherein said wireless local area network is further capable of:
transmitting channel status probe frames at a maximum transmission rate from said station management entity of said source wireless QoS station to said destination wireless QoS station;
determining whether said destination wireless QoS station acknowledges the maximum transmission rate;
using said maximum transmission rate as said physical layer transmission rate if said destination wireless QoS station acknowledges the maximum transmission rate;
decreasing the transmission rate of said channel status probe frames to be transmitted to said destination wireless QoS station;
using said decreased transmission rate as said physical layer transmission rate if said decreased transmission rate is not greater than the minimum allowable transmission rate;
transmitting channel status probe frames at said decreased transmission rate from said station management entity of said source wireless QoS station to said destination wireless QoS station;
determining whether said destination wireless QoS station acknowledges said decreased transmission rate; and
using said decreased transmission rate as said physical layer transmission rate if said destination wireless QoS station acknowledges said decreased transmission rate.

29. Computer-executable instructions stored on a computer-readable storage medium for providing Quality of Service (QoS) downstream signaling for an IEEE 802.11e Medium Access Control (MAC) layer in a wireless local area network, said computer-executable instructions comprising the steps of:
utilizing Medium Access Control (MAC) layer signaling to communicate with a higher layer signaling protocol comprising one of: a Resource ReSerVation Protocol (RSVP) higher layer signaling protocol and a Subnet Bandwidth Manager higher layer signaling protocol; and
providing a desired QoS level for said QoS downstream signaling through said higher layer signaling protocol.

30. The computer-executable instructions stored on a computer-readable storage medium as claimed in claim 29 wherein said computer-executable instructions further comprise the steps of:
creating in a network element of a wired network a connection request message comprising a PATH message of said higher layer signaling protocol for a QoS stream to be delivered to a destination wireless QoS station in a QoS basic service set of said wireless local area network, said connection request message containing QoS parameters for said QoS stream;
delivering said connection request message to said destination QoS station;
creating a connection response message comprising an RESV (Reservation Request) message of said higher layer signaling protocol in said destination QoS station in response to said connection request message;
delivering said connection response message to a designated subnet bandwidth manager in a hybrid coordinator co-located with a QoS access point of said QoS basic service set;
requesting in said designated subnet bandwidth manager a channel status update from a station management entity of said QoS access point;
obtaining in said station management entity of said QoS access point channel update information from a MAC layer management entity of said QoS access point;
delivering said channel status update information from said station management entity of said QoS access point to said designated subnet bandwidth manager; and
making an admission decision for said requested QoS stream in said designated subnet bandwidth manager using said channel status update information and said QoS parameters.

31. The computer-executable instructions stored on a computer-readable storage medium as claimed in claim 30 wherein said computer-executable instructions further comprise the steps of:
sending an internal message from said designated subnet bandwidth manager to said station management entity of said QoS access point that said requested QoS stream is admitted, said internal message comprising a source address, a destination address, and traffic identifier values;
creating in said station management entity of said QoS access point a stream identifier that comprises a source address, a destination address and a traffic stream identifier field for said QoS stream;
sending said stream identifier and said QoS parameters associated with said QoS stream to said MAC layer management entity of said QoS access point to reserve resources for said QoS stream;
sending from said MAC layer management entity of said QoS access point to said destination QoS station a QoS action frame that comprises a stream addition/modification operation and said QoS parameters;
sending an internal confirmation message from said MAC layer management entity of said QoS access point to said station management entity of said QoS access point;
sending said stream identifier and said QoS parameters of said QoS stream to a station management entity of said destination wireless QoS station; and
making an acceptance decision for said QoS stream in said station management entity of said destination wireless QoS station.

32. The computer-executable instructions stored on a computer-readable storage medium as claimed in claim 31 wherein said computer-executable instructions further comprise the steps of:
updating said station management entity of said destination wireless QoS station with stream characteristics after said QoS stream has been accepted;
sending a positive response QoS action frame to said hybrid coordinator of said QoS access point from said station management entity of said destination wireless QoS station indicating that said QoS stream has been accepted by said destination wireless QoS station;
upon receiving said positive response QoS action frame from said destination wireless QoS station, said MAC layer management entity of said QoS access point causing said scheduling entity to schedule a transmission opportunity for said QoS stream;
sending transmission opportunity scheduling information to said station management entity of said QoS access point;
sending a positive response internal message from said station management entity of said QoS access point to said designated subnet bandwidth manager; and
sending a positive response RESV (Reservation Request) message from said designated subnet bandwidth manager to said network element of said wired network that requested said QoS stream.

33. Computer-executable instructions stored on a computer-readable storage medium for providing Quality of Service (QoS) upstream signaling for an IEEE 802.11e Medium Access Control (MAC) layer in a wireless local area network, said computer-executable instructions comprising the steps of:
utilizing Medium Access Control (MAC) layer signaling to communicate with a higher layer signaling protocol comprising one of: a Resource ReSerVation Protocol (RSVP) higher layer signaling protocol and a Subnet Bandwidth Manager higher layer signaling protocol; and
providing a desired QoS level for said QoS upstream signaling through said higher layer signaling protocol.

34. The computer-executable instructions stored on a computer-readable storage medium as claimed in claim 33 wherein said computer-executable instructions further comprise the steps of:
creating in a source wireless QoS station in a QoS basic service set of said wireless local area network a connection request message comprising a PATH message of said higher layer signaling protocol for a QoS stream to be delivered to a destination network element of a wired network, said connection request message containing QoS parameters for said QoS stream;
sending said connection request message from said source wireless QoS station to said destination network element;
delivering a connection response message comprising an RESV (Reservation Request) message of said higher layer signaling protocol from said destination network element to a designated subnet bandwidth manager co-located with a hybrid coordinator in a QoS access point of said QoS basic service set;
requesting in said designated subnet bandwidth manager a channel status update from a station management entity of said QoS access point;
obtaining in said designated subnet bandwidth manager QoS parameters for said QoS stream from said connection request message and from said response message;
obtaining in said station management entity of said QoS access point channel update information from a MAC layer management entity of said QoS access point;
delivering said channel status update information from said station management entity of said QoS access point to said designated subnet bandwidth manager; and
making an admission decision for said requested QoS stream in said designated subnet bandwidth manager using said channel status update information and said QoS parameters.

35. The computer-executable instructions stored on a computer-readable storage medium as claimed in claim 33 wherein said computer-executable instructions further comprise the steps of:
sending an internal message from said designated subnet bandwidth manager to said station management entity of said QoS access point that said requested QoS stream is admitted, said internal message comprising a source address, a destination address, and traffic identifier values;
creating in said station management entity of said QoS access point a stream identifier that comprises a source address, a destination address and a traffic stream identifier field for said QoS stream;
sending said stream identifier and said QoS parameters associated with said QoS stream to said MAC layer management entity of said QoS access point to reserve resources for said QoS stream;
sending from said MAC layer management entity of said QoS access point to said source QoS station a QoS action frame that comprises a stream addition/modification operation and said QoS parameters;
sending an internal confirmation message from said MAC layer management entity of said QoS access point to said station management entity of said QoS access point;
sending said stream identifier and said QoS parameters of said QoS stream to a station management entity of said source wireless QoS station; and
making an acceptance decision for said QoS stream in said station management entity of said source wireless QoS station.

36. The computer-executable instructions stored on a computer-readable storage medium as claimed in claim 35 wherein said computer-executable instructions further comprise the steps of:
updating said station management entity of said source wireless QoS station with stream characteristics after said QoS stream has been accepted;
sending a positive response QoS action frame to said hybrid coordinator of said QoS access point from said station management entity of said source wireless QoS station indicating that said QoS stream has been accepted by said source wireless QoS station;
upon receiving said positive response QoS action frame from said source wireless QoS station, said MAC layer management entity of said QoS access point causing said scheduling entity to schedule a transmission opportunity for said QoS stream;
sending transmission opportunity scheduling information to said station management entity of said QoS access point;
sending a positive response internal message from said station management entity of said QoS access point to said designated subnet bandwidth manager; and
sending a positive response RESV (Reservation Request) message from said designated subnet bandwidth manager to said source wireless QoS station that requested said QoS stream.

37. Computer-executable instructions stored on a computer-readable storage medium for providing Quality of Service (QoS) sidestream signaling for an IEEE 802.11e Medium Access Control (MAC) layer in a wireless local area network, said computer-executable instructions comprising the steps of:
utilizing Medium Access Control (MAC) layer signaling to communicate with a higher layer signaling protocol comprising one of: a Resource ReSerVation Protocol (RSVP) higher layer signaling protocol and a Subnet Bandwidth Manager higher layer signaling protocol; and
providing a desired QoS level for said QoS sidestream signaling through said higher layer signaling protocol.

38. The computer-executable instructions stored on a computer-readable storage medium as claimed in claim 37 wherein said computer-executable instructions further comprise the steps of:
determining in a hybrid coordinator of a QoS access point in a QoS basic service set whether a source wireless QoS station in said QoS basic service set is capable of communicating directly with a destination wireless QoS station in said QoS basic service set.

39. The computer-executable instructions stored on a computer-readable storage medium as claimed in claim 37 wherein said computer-executable instructions further comprise the steps of:
creating in a source wireless QoS station in a QoS basic service set of said wireless local area network a connection request message comprising a PATH message of said higher layer signaling protocol for a QoS stream to be delivered to a destination wireless QoS station in said QoS basic service set, said connection request message containing QoS parameters for said QoS stream;
delivering said connection request message from said source wireless QoS station to said destination wireless QoS station;
creating a connection response message comprising an RESV (Resource Reservation) message of said higher layer signaling protocol in said destination wireless QoS station in response to said connection request message;
delivering said connection response message from said destination wireless QoS station to a designated subnet bandwidth manager co-located with a hybrid coordinator in a QoS access point of said QoS basic service set;
requesting in said designated subnet bandwidth manager a channel status update from a station management entity of said QoS access point;
sending an action frame message from a MAC layer management entity of said QoS access point to said source wireless QoS station to initiate a channel status update;
determining in a station management entity of said source wireless QoS station a physical layer transmission rate between said source wireless QoS station and said destination wireless QoS station;
performing a channel status update in said source wireless QoS station to determine said physical layer transmission rate; and
sending said physical layer transmission rate to said MAC layer management entity of said QoS access point with a response action frame.

40. The computer-executable instructions stored on a computer-readable storage medium as claimed in claim 39 wherein said computer-executable instructions further comprise the steps of:
sending a response action frame from said MAC layer management entity of said QoS access point to said station management entity of said QoS access point;
determining in said station management entity of said QoS access point whether a minimum transmission rate between said source wireless QoS station and said destination wireless QoS station is achievable; and
when it is not possible for said source wireless QoS station and said destination wireless QoS station to communicate with each other directly, using said QoS access point to send said QoS stream after determining that said minimum transmission rate is not achievable.

41. The computer-executable instructions stored on a computer-readable storage medium as claimed in claim 40 wherein said computer-executable instructions further comprise the steps of:
sending an internal message from said station management entity of said QoS access point to said designated subnet bandwidth manager that informs said designated subnet bandwidth manager which type of communication between said source wireless QoS station and said destination wireless QoS station is being used; and
sending a higher layer response message comprising an RESV (Reservation Request) message of said higher layer signaling protocol from said designated subnet bandwidth manager to said source wireless QoS station to update a QoS protocol connection.

42. The computer-executable instructions stored on a computer-readable storage medium as claimed in claim 39 wherein wherein the step of determining in a station management entity of said source wireless QoS station a physical layer transmission rate between said source wireless QoS station and said destination wireless QoS station comprises the steps of:
transmitting channel status probe frames at a maximum transmission rate from said station management entity of said source wireless QoS station to said destination wireless QoS station;
determining whether said destination wireless QoS station acknowledges the maximum transmission rate;
using said maximum transmission rate as said physical layer transmission rate if said destination wireless QoS station acknowledges the maximum transmission rate;
decreasing the transmission rate of said channel status probe frames to be transmitted to said destination wireless QoS station;
using said decreased transmission rate as said physical layer transmission rate if said decreased transmission rate is not greater than the minimum allowable transmission rate;
transmitting channel status probe frames at said decreased transmission rate from said station management entity of said source wireless QoS station to said destination wireless QoS station;
determining whether said destination wireless QoS station acknowledges said decreased transmission rate; and
using said decreased transmission rate as said physical layer transmission rate if said destination wireless QoS station acknowledges said decreased transmission rate.
